(19) United States
(12) Patent Application Publication
(10) Pub. No.: US 2004/0024709 A1
(43) Pub. Date: Feb. 5, 2004

(54) System and method for determining the identity of a party associated with a transaction

(76) Inventors: Paul D. Yu, Clifton, VA (US); J. Banks Hyde, Washington, DC (US)

Correspondence Address: Poh C. Chua, Shaw Pittman LLP, 1650 Tysons Blvd., McLean, VA, 22102-4859, US

(21) Appl. No.: 10/630,867

(22) Filed: Jul. 31, 2003

Related U.S. Application Data
(60) Provisional application No. 60/400,684, filed on Aug. 5, 2002.
(60) Provisional application No. 60/406,300, filed on Aug. 28, 2002.
(60) Provisional application No. 60/427,578, filed on Nov. 20, 2002.
(60) Provisional application No. 60/430,352, filed on Dec. 3, 2002.

(51) Int. Cl. G06F 17/60

(52) U.S. Cl. 705/43; 705/41

(57) ABSTRACT

Systems and methods for determining identities of transaction parties are disclosed. One embodiment of the invention provides a method for determining identities of transaction parties including: capturing a transaction image of a transaction party conducting a transaction at a transaction device at the time of the transaction; associating the transaction image with transaction information generated by the transaction device; and using the transaction image to verify whether the transaction party has an authority to conduct the transaction. Preferably, the associating includes cross-referencing the transaction image with the transaction information at the time of the transaction. The transaction information can include information related to one or more of date and time of the transaction. The transaction information can also include information related to the transaction device.

The present invention claims the benefits of U.S. Provisional Patent Application Serial No. 60/400,684 (filed Aug. 5, 2002), No. 60/406,300 (filed Aug. 28, 2002), No. 60/427,578 (filed Nov. 20, 2002), and No. 60/430,352 (filed Dec. 3, 2002), each of which is incorporated by reference in its entirety.

### BACKGROUND OF THE INVENTION

1. Field of the Invention

The present invention relates generally to electronic transactions and, more particularly, to systems and methods for determining the identity of a party associated with an electronic transaction.

2. Background of the Invention

A large number of electronic transactions are being conducted at electronic transaction devices each day. Electronic transactions include, for example, a cash withdrawal at an automated teller machine (ATM) and a credit card sale at a retail point of sale (POS) terminal register.

Currently, the identity of a party associated with the electronic transaction is determined using a number of methods. For example, in the case of an ATM withdrawal, the identity of the person who takes money out of the ATM is determined by a personal identification number (PIN) provided by the person. In the case of a retail sale, the customer presents his or her credit card and provides a signature, which is used to authenticate the customer's identity. None of these methods provides a satisfactory solution to determine the identity of the party associated with the transaction. For example, banks continue to receive challenges from their customers who dispute ATM transactions. Similarly, credit card frauds continue to remain as a major problem for the society.

Accordingly, there is a need for a system and method that can reliably determine the identity of the party who conducts or conducted an electronic transaction.

### SUMMARY OF THE INVENTION

Systems and methods for determining identities of transaction parties are disclosed. One embodiment of the invention provides a method for determining identities of transaction parties including: capturing a transaction image of a transaction party conducting a transaction at a transaction device at the time of the transaction; associating the transaction image with transaction information generated by the transaction device; and using the transaction image to verify whether the transaction party has an authority to conduct the transaction. Preferably, the associating includes cross-referencing the transaction image with the transaction information at the time of the transaction. The transaction information can include information related to one or more of date and time of the transaction. The transaction information can also include information related to the transaction device.

Another embodiment of the invention provides a method for processing transactions. The method includes: storing an authenticated image of a person authorized to conduct transactions at a transaction device; capturing a transaction image of a transaction party conducting a transaction at the transaction device during the transaction; and comparing the transaction image with the authenticated image to determine whether the transaction party shown in the transaction image is the person shown in the authenticated image. Preferably, the authenticated image is captured when the person is authorized to use the transaction device. Alternatively, the authenticated image is one of previously undisputed transaction images. Preferably, the comparing is performed before the transaction is approved. Using the result, the transaction can be either approved or denied. In another implementation, the comparing is performed after the transaction has been concluded. For example, the comparing can be performed to resolve a dispute related to the transaction.

In another embodiment, the invention provides a system that includes a transaction device, an image device, and a database. The transaction device is configured to generate transaction information associated with a transaction performed by a transaction party. The transaction information is associated with a reference number. The image device is coupled to the transaction device. The image device is configured to capture a transaction image of the transaction party while the transaction party is conducting the transaction at the transaction device. The transaction image is associated with the reference number. The database is coupled to the image device. The database is configured to store the transaction image. The transaction image is retrievable from the database using the reference number. The transaction device is an electronic device that is configured to verify identity of transaction parties electronically. For example, the transaction device can be an automatic teller machine, a point of sale terminal, or a passport scanning machine. The image device can be a camera or a video recording device.

### BRIEF DESCRIPTION OF THE DRAWINGS

FIG. 1 a schematic diagram showing the system of a preferred embodiment of the invention.

FIG. 2 is a flowchart showing an exemplary process that can be used to implement one embodiment of the invention.

FIG. 3 is a flowchart showing another exemplary process that can be used to implement another embodiment of the invention.

FIG. 4 is a schematic diagram showing an exemplary system that determines the legitimacy of a transaction at an ATM.

FIG. 5 is an exemplary transaction detail associated with an ATM transaction.

FIG. 6 is another exemplary transaction detail associated with an ATM transaction.

FIG. 7 is another exemplary transaction detail associated with an ATM transaction.

FIG. 8 is a schematic diagram showing an exemplary scenario involved in using an embodiment of the dispute resolution network of the invention.

FIG. 9 is a schematic diagram showing an exemplary scenario involved in using another embodiment of the invention.

FIG. 10 illustrates the current state of the art in integrating transaction information with images (e.g., video) at a known ATM.

FIG. 11 is a schematic diagram showing how a visible proof data center of the invention relate to existing components of an ATM system.

FIG. 12 is a schematic diagram showing the system of an embodiment of the present invention.

FIG. 13 illustrates the relationships between the possible frameworks (e.g., libraries) necessary to support a suite of applications of a retail digital hub that works with cameras with built-in recording capabilities according to an embodiment of the present invention.

FIG. 14 illustrates the data flow within the retail digital hub as it processes ATM transactional data from an ATM and the video data from a camera for transmission to a data center according to an embodiment of the present invention.

FIG. 15 illustrates the relationships between the possible frameworks (libraries) necessary to support the suite of applications of the retail digital hub that includes a built-in digital video recorder and works with traditional analog video cameras according to an embodiment of the present invention.

FIG. 16 illustrates the data flow within the retail digital hub as it processes ATM transactional data from the ATM and the video from camera for transmission to the data center according to an embodiment of the present invention.

FIG. 17 illustrates the multi-tier relationship between the various systems in the data center to deal with the massive amounts of both transactional and video data according to an embodiment of the present invention.

FIG. 18 illustrates the architecture of application servers according to an embodiment of the present invention.

FIG. 19 illustrates major processes on batch applications to process the incoming video and encoded transactions from ATMs according to an embodiment of the present invention.

FIG. 20 illustrates an exemplary structure of a visible proof ATM application portal of the invention.

FIG. 21 is a more detailed illustration of the sequence of screens/pages 2010, 2011, 2012, 2013, and 2015 shown in FIG. 20 according to an embodiment of the present invention.

FIG. 22 is a more detailed illustration of the sequence of screens/pages 2020, 2021, 2022, 2023, and 2015 according to an embodiment of the present invention.

FIG. 23 is a more detailed illustration of the sequence of screens/pages 2030, 2031, and 2032 according to an embodiment of the present invention.

FIG. 24 is a schematic diagram showing the data flow associated with a preferred embodiment of the invention.

FIG. 25 is an exemplary report that can be generated by a visible proof exchange system of the invention.

FIG. 26 is another exemplary report that can be generated by a visible proof exchange system of the invention.

FIG. 27 is an exemplary page showing a transaction image associated with a disputed transaction.

FIG. 28 is an exemplary report that can be generated by a visible proof exchange system of the invention to display historic customer disputes.

FIG. 29 is a schematic diagram showing an exemplary system that resolves a dispute associated with a retail POS (point of sale) transaction.

FIG. 30 is a flowchart showing an exemplary process that may be used to implement a preferred embodiment of the present invention.

FIG. 31 is a flowchart showing another exemplary process that may be involved in using another preferred embodiment of the present invention.

FIG. 32 illustrates an exemplary system architecture of a preferred embodiment of the invention related to retail stores.

FIG. 33 illustrates an exemplary hardware architecture that can be implemented in a retail store, which is part of a network of the invention.

FIG. 34 illustrates another exemplary hardware architecture that can be implemented in store 3220 of network 3200 shown in FIG. 32.

FIG. 35 shows an exemplary flow of video and textual data between the various devices shown in FIG. 33.

FIG. 36 shows the flow of video and textual data between the various devices shown in FIG. 34, where a digital camera is used instead of an analog camera.

FIG. 37 illustrates the data flow within retail digital hub 3310 as it processes the point-of-sales (POS) transactional ASCII data and the video data for transmission to the network data center 3210.

FIG. 38 illustrates the data flow within retail digital hub 3310 as it processes the signature pad (“SigPad”) transactional ASCII data and the video data for transmission to the network data center 3230.

FIG. 39 illustrates the multi-tier relationship between the various systems in data center 3230 to deal with the massive amounts of both transactional and video data.

FIG. 40 illustrates the architecture of the Visible Proof and Visible Evidence Applications.

FIG. 41 illustrates the major processes necessary to receive the video and transaction files from the retail stores and processes them for storage at the data center and later retrieval by the customers.

FIG. 42 illustrates the batch process to analyze POS transactions for suspicious activity based on the reporting parameters set by the store owners or their loss prevention specialists, and assign these transactions to active case folders for the store owners to review.

FIG. 43 illustrates an exemplary electronic notification process that can be used to alert the storeowner customer of potentially interesting transactions for their review.

FIG. 44 illustrates an exemplary structure of visible proof portal application 4010 to all retail store owners to access the POS transactions and the associated video from their web-browser.

FIG. 45 illustrates an exemplary screen depicting the integration of textual POS transaction information.

FIG. 46 illustrates the major processes on the application servers to process the incoming video and encoded transactions from the retail stores.

FIG. 47 illustrates the batch process to analyze credit card or debit card transactions for suspicious activity based on the reporting parameters set by the financial institutions, and assign these transactions to active case folders for the financial institutions to review.

FIG. 48 illustrates the electronic notification processes to alert the financial institution customer of potentially fraudulent credit card purchase transaction for their review.

FIG. 49 illustrates the sample structure of visible evidence portal application 4020 to all financial institutions to access the credit and debit card transactions and the associated video from their web-browser.

FIG. 50 illustrates a sample screen depicting the integration of textual credit card transaction information with the video images of the cardholder signing on a signature pad with camera device (e.g., authorizing device 3320 shown in FIG. 33).

FIG. 51 is a schematic diagram showing a preferred embodiment of a signature pad with camera device of the invention.

FIG. 52 illustrates the invention using a camera connected POS terminal 5130 through serial connection 5122.

FIG. 53 illustrates a preferred position of camera 5111 to capture a transaction image of transaction party 5302.

FIG. 54 is a schematic showing relative positions of user input device 5110, camera 5111, and POS terminal 5130.

FIG. 55 is a flowchart showing an exemplary process associated with the controlling of camera 5111.

FIG. 56 is an exemplary transaction detail of the invention.

### DETAILED DESCRIPTION OF THE INVENTION

In one aspect, the present invention relates to capturing a transaction image of a transaction party associated with an electronic transaction. The transaction party can be a person who is withdrawing cash from an automatic teller machine (ATM), a credit card holder who is using her credit card to pay for an item, a store employee who is conducting electronic transactions at a retail outlet, a traveler who is presenting his passport to an immigration agent, a computer user who is trying to access a secured network, or a person who is accessing a secured building. Various embodiments of the invention are directed to determining the identity of the transaction party during the associated transactions.

An exemplary system of the invention includes an image device that is coupled to a transaction device. The image device is used to capture a transaction image of a transaction party during an electronic transaction. The transaction image can be captured by the image device at an appropriate time during the electronic transaction. The appropriate time can include an instance of time (still photograph) or a duration of time (video clip). The appropriate time can include one or more of before the transaction, during the transaction, and after the transaction. Preferably, the transaction image includes a frontal view of the transaction party. For example, the transaction image shows the face of the transaction party.

Preferably, the transaction device and image device are in communication with or otherwise coupled to one another so that the image device can be triggered or activated/deactivated by the transaction device. Preferably, the transaction device and the image device are an integrated unit. However, the transaction device and the image device can be two separate units. Coordination between the image device and the transaction device is done to ensure that the best transaction image can be captured during the appropriate time of the transaction. For example, in the case of an ATM cash withdrawal, the transaction image preferably include the instance when the PIN is being entered by the transaction party. In the case of a credit card transaction, the transaction image is preferably captured as the party who uses the credit card is providing her signature.

The transaction image is preferably stored in a database. The transaction image is retrievable using a number of different methods. For example, transaction information associated with the transaction can be used to retrieve the transaction image. Preferably, the transaction image can also be retrieved using one or more of a reference number, an index number, or another information retrieval device. The transaction information can include, among other things, date and/or time of the transaction, identification (e.g., serial number) of the transaction device, location of the transaction device, and other information associated with the transaction.

The transaction image is preferably stored in a way that it can be easily retrieved based on, for example, the transaction information associated with the electronic transaction. Preferably, a storage device or repository is coupled to the image device so that the transaction image can be kept in a database embodied in the storage device. In addition, this repository is preferably coupled to the transaction device so that transaction information generated by the transaction device can also be stored in the repository.

Preferably, the transaction image and the transaction information are associated with each other by cross referencing. The cross reference can then be used to retrieve the transaction information based on the transaction image, and vice versa. The repository can preferably be queried by a user of the invention (e.g., a legitimate ATM cardholder, the owner of a credit card, a bank, a dispute resolution agency, etc.) through either a web browser or an other client software to settle disputes. Known disputes includes assertions that the transaction party is not a person authorized to conduct the transaction in question. The transaction image is used to determine whether the transaction party captured in the transaction image is one with authority to conduct the transaction. Transaction devices that can benefit from or incorporate the present invention include ATMs, retail POS registers or terminals, computers associated with a network, cellular telephones, personal digital assistants, passport scanning machines, building access systems, and other like electronic devices.

For example, in an embodiment of the present invention directed to ATMs, the ATM is the transaction device. Preferably, the ATM is configured to include a camera (an image device) so that the ATM and camera combination can act as the source of both transaction record (transaction information) and video data (transaction image) for a transaction repository or storage device. This repository stores transaction record (transaction information) associated with the ATM in a database with a cross reference from the transaction record to the ATM's video record (transaction image) of the event. The repository can be queried by a financial institution (such as a bank associated with the ATM or the ATM card in question) to resolve disputes associated with transactions conducted at the ATM. Through either a web browser or another client software, the transaction image can be retrieved and then used to determine whether the transaction party captured in the transaction image is an authorized person who has authority to conduct the disputed transaction.

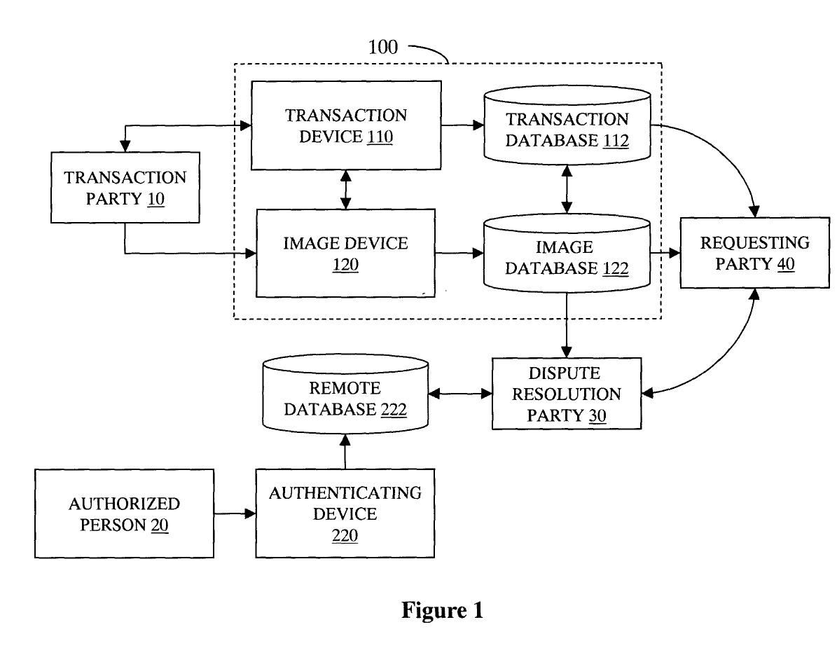

FIG. 1 a schematic diagram showing the system of a preferred embodiment of the invention. System 100 includes transaction device 110 and image device 120. As discussed above, transaction device 110 and image device 120 can be two separate units or they can be one integrated unit.

Transaction device 110 can be any electronic device at which an electronic transaction can be performed by transaction party 10. For example, transaction device 110 can be an ATM, a POS terminal, a passport scanning machine, or another device. Transaction device 110 is configured to generate transaction information or transaction record, which may include one or more of date of transaction, time of transaction, identity of transaction device 110 (e.g., a serial number or IP address), a geographical location at which transaction device 110 is situated, amount of funds involved, and other information associated with the electronic transaction.

Image device 120 can be any device that can capture an image of transaction party 10 who is associated with the electronic transaction. Transaction party 10 can be, for example, a person withdrawing cash from an ATM, a POS cashier, or a credit holder. Image device 120 is coupled to transaction device 110. Image device 120 captures a transaction image at an appropriate time during the electronic transaction. The transaction image can be a video clip or a still photograph. Preferably, the transaction image includes a frontal view (e.g., the face) of transaction party 10. Preferably, the transaction image captures a critical instance of the electronic transaction. The critical instance can be, for example, the moment the electronic transaction is initiated, the moment when transaction party 10 provides an input (e.g., a PIN or a signature) to transaction device 110, or the moment transaction party 10 retrieves something (e.g., cash) from transaction device 110.

System 100 preferably includes transaction database 112. Transaction database 112 is configured to store transaction information associated with transaction device 110. For example, transaction information generated by transaction device 110 can be stored in transaction database 112.

System 100 preferably includes image database 122. The transaction image captured by image device 110 can be stored in image database 122. Image database 122 and transaction database 112 can be an integrated component of system 100. Alternatively, image database 122 and transaction database 112 can be two separate units, as shown in FIG. 1. In other embodiments, one or both transaction database 112 and image database 122 can be separated from system 100 and be part of a different system.

Using the transaction information associated with a transaction, one or more transaction images associated with the transaction can be retrieved from image database 122. Similarly, using a transaction image associated with transaction, transaction information associated with that transaction can be retrieved from transaction database 112. Cross referencing of transaction information and transaction images can be done in a number of ways. For example, transaction information and transaction images associated with a common transaction can have an identical index number. The index number can be generated, for example, based in part on the date and time of the electronic transaction and/or other information associated with the transaction.

Requesting party 40 can be any party that has access to transaction database 112, either directly or indirectly. Requesting party 40 can be anyone who wishes to know, determine, verify, or otherwise authenticate the identity of transaction party 10. Transaction party 10, even though in fact conducted a transaction at transaction device 110, may or may not be a person authorized to conduct the transaction. Using transaction information available from transaction database 112, requesting party 40 can retrieve the transaction image associated with the transaction in question from image database 122. Since the image captured by image device 120 during the electronic transaction provide a frontal view of transaction party 10 during the electronic transaction in question, the identity of transaction party 10 can be ascertained by requesting party 40.

In another aspect of the invention, requesting party 40 can defer the verification process to dispute resolution party 30. For example, if requesting party 40 for one reason or another does not have access to image database 122, dispute resolution party 30 can retrieve images from image database 122 based on transaction information received from requesting party 40. Using the transaction information, dispute resolution party 30 accesses image database 122 to retrieve the transaction image. A resolution can then take place upon a determination of the identity of transaction party 10 based on the transaction image. If transaction party 10 is determined to be a person having authorization to conduct the electronic transaction in question, then the electronic transaction would be considered to be legitimate. Otherwise, a fraudulent transaction would be considered to have taken place.

In another aspect of the invention, dispute resolution party 30 has access to remote database 222. Remote database 222 contains, among other things, one or more authenticated images of persons authorized to conduct electronic transactions at transaction device 110. The authenticated images can be captured by authenticating device 220. The authenticated images are those of authorized person 20. Authenticating device 220 can be, for example, a camera. The authenticated images can be still photographs or video clips.

In such implementation of the invention, dispute resolution party 30 can compare the transaction image of transaction party 10 retrieved from image database 122 with one or more authenticated images of authorized person 20. If transaction party 10 is determined to be authorized person 20, then the electronic transaction would be considered legitimate. Otherwise, transaction party 10 would be considered to have conducted an unauthorized electronic transaction at transaction device 110.

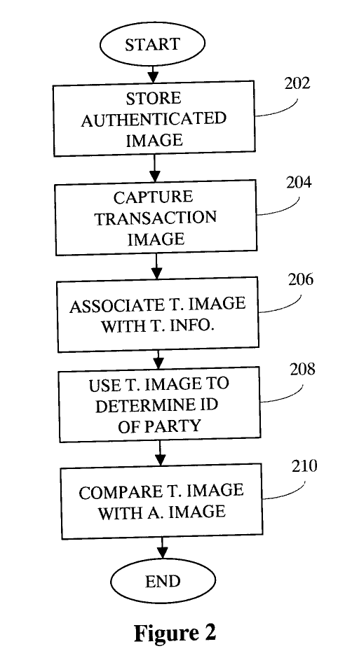

FIG. 2 is a flowchart showing an exemplary process that can be used to implement one embodiment of the invention. The exemplary process may be performed by, for example, one or both of dispute resolution party 30 and requesting party 40 shown in FIG. 1. In this implementation, requesting party 40 has access to image database 122.

In step 202, an optional step, an authenticated image of authorized person 20 is captured by authenticating device 220 and stored in remote database 222. Preferably, the authenticated image of authorized person 20 is captured at the time authorized person 20 is granted authority to conduct transactions at transaction device 110. For example, when a bank customer (authorized person 20) opens a bank account and is issued an ATM card, a photograph (authenticating image) of the customer is captured and stored in remote database 222.

In step 204, a transaction image is captured during a transaction at transaction device 110. For example, when transaction party 10 (who may or may not be authorized person 20) conducts an electronic transaction at transaction device 110, image device 120 captures an image of transaction party 10.

In step 206, the transaction image captured in the previous step is associated with transaction information of the electronic transaction conducted by transaction party 10. For example, the transaction image is formatted, labeled, or otherwise embedded with the transaction information. For example, a filename of the transaction image may include or otherwise be coded with one or more of the transaction date, the transaction time, the identification of transaction device 110, the location of transaction device 110, and other transaction information associated with the transaction. The transaction image is stored in image database 122.

In step 208, using the transaction information, the transaction image captured by image device 120 is retrieved from image database 122. The transaction image is then reviewed to determine the identity of transaction party 10. For example, when authorized person 20 disputes the legitimacy of the transaction, the transaction image of transaction party 10 can be shown to authorized person 20. If transaction party 10 is authorized person 20 or another person authorized by authorized person 20 to conduct the transaction, the transaction would be considered to be legitimate. Otherwise, transaction party 10 would be considered to have conducted an illegitimate transaction at transaction device 110.

Step 210 is an optional step that can be taken if an authenticated image was previously captured and stored in step 202. In this step, the transaction image is compared with the authenticated image to determine the identity of the transaction party 10.

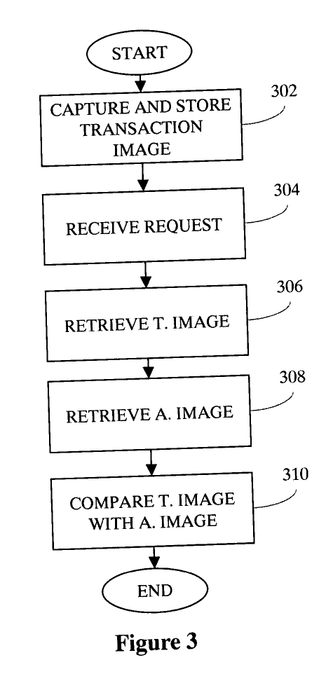

FIG. 3 is a flowchart showing an exemplary process that can be use to implement another embodiment of the invention. This exemplary process may be performed by, for example, dispute resolution party 30 shown in FIG. 1. In this implementation, requesting party 40 does not have direct access to image database 122 or remote database 222. Dispute resolution party 30 has access to image database 122 and remote database 222.

In step 302, a transaction image associated with an electronic transaction at transaction device 110 is captured and stored by system 100. For example, when transaction party 10 conducts an electronic transaction at transaction device 110, image device 120 captures an image of transaction party 10. The transaction image is stored in image database 122. The transaction image is associated with transaction information generated by transaction device 110. The association can include a reference number. The reference number can include some or all information related to the transaction, as described above.

In step 304, a request to determine the identity of transaction party 10 is received by dispute resolution party 30. The request may be generated by, for example, requesting party 40. Requesting party 40 can be, for example, a credit card company who wishes to resolve a disputed credit card transaction if the transaction in question was a credit card sale. The request includes transaction information associated with the electronic transaction. The transaction information preferably include the reference number stated above. The transaction information can also include other information such as the name of transaction party 10.

In step 306, using the transaction information received from requesting party 40, the transaction image is retrieved by dispute resolution party 30. The transaction image can be retrieved by dispute resolution party 30 from image database 122. If requesting party 40 had access to image database 122, the transaction image may be provided by requesting party 40 to dispute resolution party 30 as part of the request.

In step 308, using the information provided by requesting party 40, e.g., the name of transaction party 10, the authenticated image is retrieved from remote database 222. The authenticated image is an image of a person authorized to conduct the transaction in question. For example, the authenticated image is a photograph of authorized person 20 previously authorized by requesting party 40 to conduct transactions at transaction device 110.

In step 310, the transaction image is compared with the authenticated image to determine the identity of the transaction party 10. Based on the comparison, a determination can be made on whether transaction party 10 is authorized person 20.

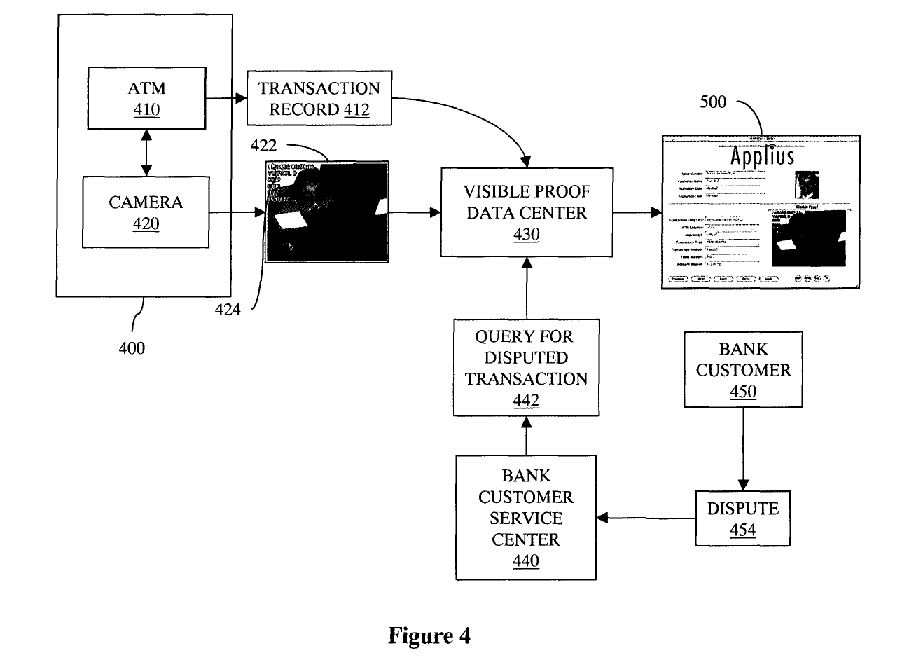

FIG. 4 is a schematic diagram showing an exemplary system that determines the legitimacy of a transaction at an ATM. In one instance of this implementation, the customer service center of a bank (an exemplary requesting party 40) associated with ATM 410 (an exemplary transaction device 110) accesses visible proof data center 430 (an exemplary image database 122) to verify whether an ATM user (an exemplary transaction party 10) who withdrew cash (an exemplary transaction) from ATM 410 was indeed a customer of the bank (an exemplary authorized person 20).

ATM 410 and camera 420 are members of system 400 of the invention. A transaction party can conduct a number of transactions at ATM 410. For example, by inserting an ATM card and entering a personal identification number (PIN) associated with that ATM card, the transaction party can withdraw cash from ATM 410. In the present invention, ATM 410 is coupled with camera 420 (an exemplary image device 120). Camera 420 is configured to capture transaction image 422. Preferably, as shown in FIG. 4, camera 420 is configured to capture the face of the transaction party, as shown in transaction image 422. ATM 410 can also generate transaction record 412 (exemplary transaction information) that can include, among other things, the date and time of the transaction, the ATM card number, the location of ATM 410, and bank or banks associated with ATM 410.

Camera 420 can be analog or digital, and it can be a still photograph camera or a video recording device. Preferably, camera 420 is a digital video recording device that can produce digital images that can be digitally processed. If camera 420 is an analog device, a digital processor is coupled to camera 420 so that transaction image 422 can be processed digitally. Preferably, transaction image 422 captured or generated by camera 420 includes some or all transaction information in portion 424 of transaction image 422. Camera 420 transmits transaction image 422 to visible proof data center 430. Transaction image 422 can be stored either locally or in a centralized database. If transaction image 422 is stored locally within system 100 rather than in the centralized database, camera 420 is preferably coupled to a processor that can respond to requests for transaction image 422 by sending transaction image 422 to the requestor.

After the transaction is completed at ATM 410, transaction record 412 and transaction image 422 are stored in visible proof data center 430. Alternatively, transaction record 412 and transaction image 422 can be initially stored at a local storage coupled to system 100, and later be transferred to visible proof data center 430. Visible proof data center 430 can receive transaction record 412 and transaction image 422 from the local storage of system 100 via any known file transfer methods.

In due time, bank customer 450 (an exemplary authorized person 20 who may or may not be the transaction party) receives a statement that reports all activities associated with his ATM card. For example, bank customer 450 receives a statement that includes information contained in transaction record 412. The statement may contain, for example, the date and time of the transaction, the location or reference number of ATM 410, and an amount of the transaction. If bank customer 450 has a question regarding the transaction that took place at ATM 410, or challenges that he did not use his ATM card to conduct the transaction in question, bank customer 450 can file dispute 454 with his bank.

Bank customer 450 can submit dispute 454 in the form of a walk-up, face-to-face, written report, telephone call, e-mail, web-site submission or any other means acceptable to bank customer service center 440 (an exemplary dispute resolution party 30). Dispute 454 preferably includes some information that is part of transaction record 412. For example, dispute 454 preferably includes the date and time of the transaction, as well as the location or an identity of ATM 410.

After bank customer service center 440 receives dispute 454, bank customer service center 440 launches query 442. Query 442 can include, for example, an access to visible proof data center 430.

Using the, information provided in dispute 454, bank customer service center 440 accesses or retrieves one or both transaction record 412 and transaction image 422. Since transaction image 422 and transaction record 412 were created at about the same time during the transaction at ATM 410, both of them can be easily cross-referenced to each other and be retrievable easily by bank customer service center 440.

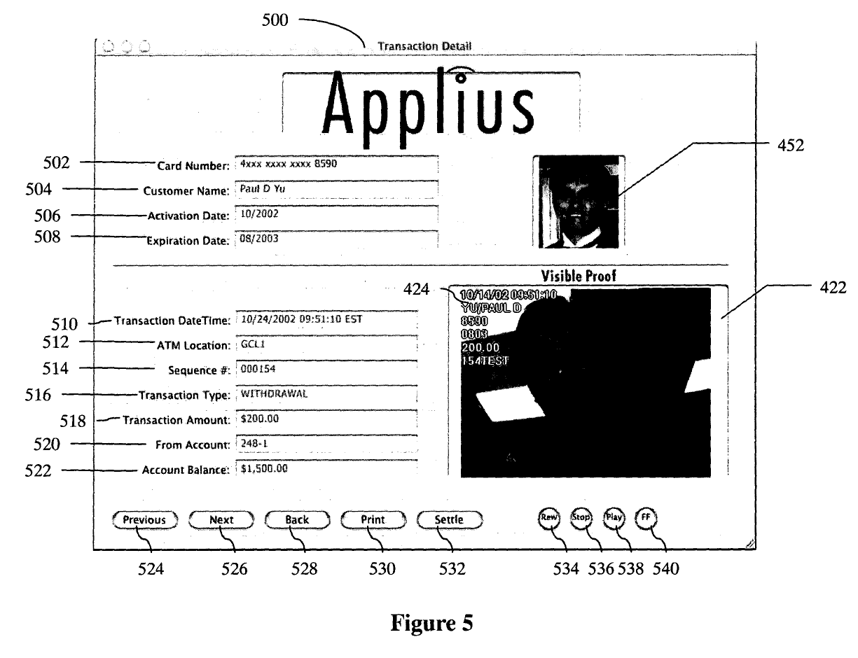

Visible proof data center 430 is configured to generate transaction detail 500. FIG. 5 is an exemplary transaction detail associated with an ATM transaction. As shown in FIG. 5, transaction detail 500 includes a number of fields that are configured to display information associated with transaction record 412. For example, fields 502, 504, 506, and 508 can be used to display card number (e.g., a unique number associated with the ATM card), customer name (e.g., name of an authorized person or bank customer 450), activation date (e.g., the date on which the card was activated), and expiration date (e.g., the date on which the card is no longer usable), respectively. Moreover, fields 510, 512, 514, 516, 518, 520, and 522 can be used to display transaction date and time, ATM location, sequence number, transaction type, transaction amount, account number, and account balance, respectively, that are associated with a particular transaction at ATM 410.

In accordance with a preferred embodiment of the invention, transaction detail 500 includes transaction image 422 and authenticated image 452. As seen on the upper left corner of transaction image 422, portion 424 of transaction image 422 includes, among other things, information displayed in fields 510, 504, 508, and 518. Authenticated image 452 is an image of bank customer 450. Preferably, authenticated image 452 was captured at the time when bank customer 450 requested for the ATM card. As described below, authenticated image 452 can also be a transaction image associated with a previously undisputed transaction.

A comparison of transaction image 422 with authenticated image 452 by bank customer service center 440 helps determine whether the transaction party shown in transaction image 422 is indeed bank customer 450 shown in authenticated image 452. If so, the dispute should be resolved such that the transaction in question is considered to be legitimate. Otherwise, the transaction in question should be considered fraudulent and appropriate actions should be taken.

If transaction image 422 was captured by a video recording device, transaction detail 500 preferably includes capabilities to play the video clip. For example, buttons 534, 536, 538, and 540 can be included to rewind, stop, play, and fast forward the video clip, respectively. The start time of the video clip can be, for example, one of the time when the transaction party comes within the camera range, the time when the transaction party inserts a card, the time when a PIN is being input by the transaction party, and the like. Similarly, the end time can be one of the time when the transaction party removes a card, cash, or receipt, the time when the transaction party walks out of the range of the camera, and the like.

Preferably, transaction detail 500 can be displayed or animated on a computer screen. Preferably, transaction detail 500 is available via a computer network. The connection between bank customer service center 440 and visible proof data center 430 can be by any computer network, including the Internet, a virtual private network, an intranet, a local area network, a wide area network and any combination of such computer networks.

Preferably, transaction detail 500 can further include additional features. For example, button 524 can be used to retrieve a previous transaction detail and button 526 can be used to retrieve the next transaction detail. The previous and next transaction details can be those that are associated with bank customer 450, whether or not conducted at ATM 410. Alternatively, the previous and next transaction details can be those that are associated with ATM 410, whether or not associated with bank customer 450. Other associations are possible.

Button 528 can be used, for example, to back up one screen during visible proof data center access session. Button 530 can be used, for example, to print a copy of transaction detail 500. Button 532 can be used, for example, to settle the dispute. For example, when button 532 is pressed, a different interface can be brought up so that a user of the invention can further process the dispute. For example, in the next interface, the dispute can be closed, deferred, or otherwise disposed of.

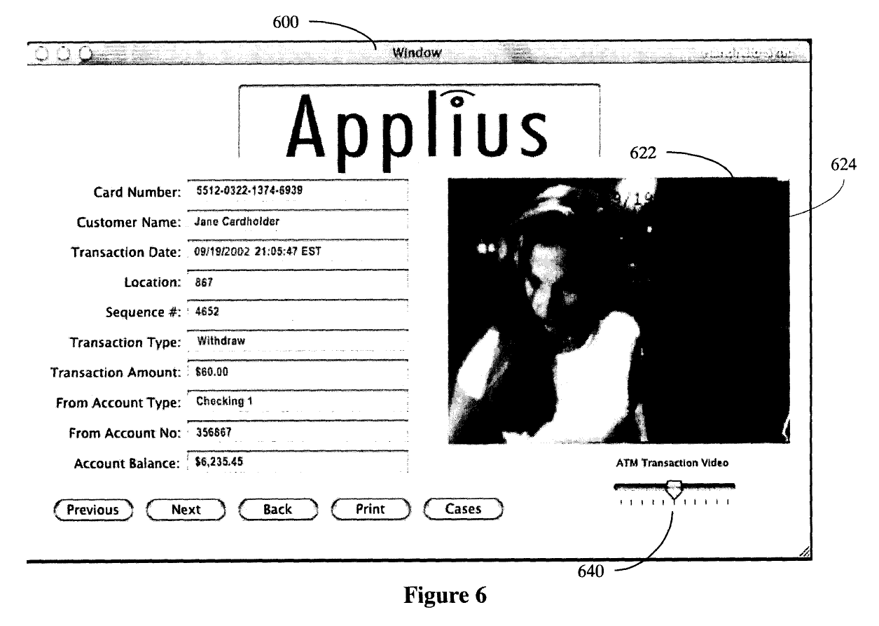

FIG. 6 is another exemplary transaction detail associated with an ATM transaction. Transaction detail 600 includes transaction image 622 and time lapse bar 640. As depicted in FIG. 6, time lapse bar 640 indicates that transaction image 622 is at about the midpoint of a video clip associated with the transaction. Note that some or all transaction information can be superimposed on portion 624 of transaction image 622.

In another implementation of the invention, prior undisputed transaction images can be to serve as an authenticated image. In such implementation of the invention, bank customer service center 440 reviews one or more transaction images associated with prior, non-disputed transaction images captured during previous, non-disputed transactions. A comparison of these previous, non-disputed transaction images with the current transaction image would determine whether the transaction is legitimate. Bank customer service center 440 can search as many previous transaction images as needed. Preferably, transaction images associated with transactions more than 30 days old are used as the authenticated image. These 30-day or older images are preferable because a customer would ordinary have already challenged these transactions if there were disputes. The assumption here is that if prior transactions were not disputed, there is a strong presumption that the transaction images previously captured would be associated with an authorized person, and can therefore be considered as “authenticated” images for the purposes of dispute resolution. Use of previously undisputed transaction images as the authenticated image is beneficial because they provide more recent pictures of bank customer 450.

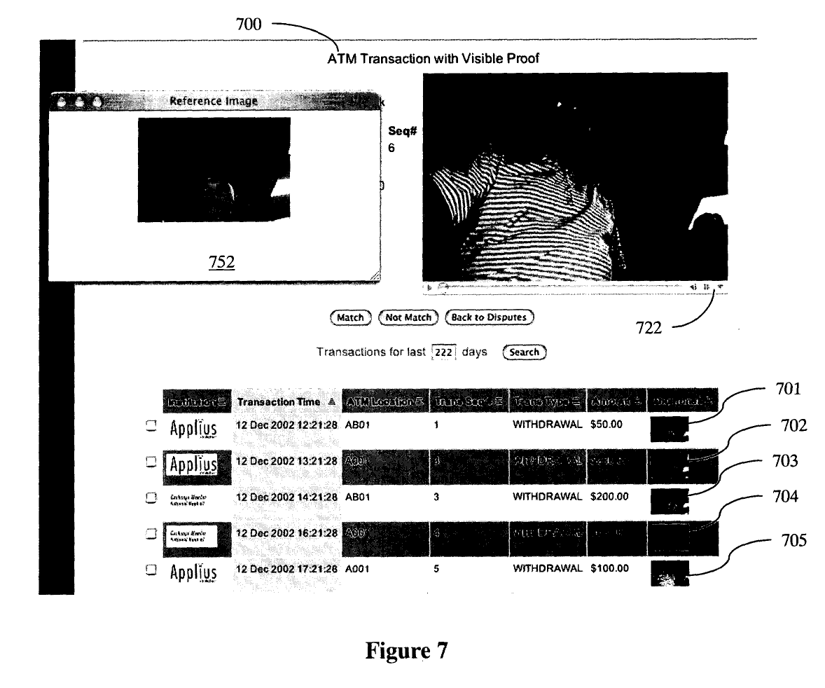

FIG. 7 is another exemplary transaction detail associated with an ATM transaction. In transaction detail 700, authenticated image 752 is one of previously stored transaction images. For example, authenticated image 752 is a transaction image associated with an undisputed transaction. Preferably, as noted above, following a number of days, especially after bank customer 450 had a chance to review all transaction reported in a bank statement, any transaction images associated with any undisputed transaction shown on that statement can be used as authenticated image 752.

FIG. 7 shows transaction records 701, 702, 703, 704, and 705. Each of transaction records 701, 702, 703, 704, and 705 includes transaction information and a transaction image. For example, each transaction record indicate the financial institution that operates the ATM associated with the transaction, the transaction time, the ATM location, the transaction sequence number, the transaction type, the amount involved in the transaction, and the transaction image. For the purposes of discussion, transaction records 701, 702, 703, and 704 are associated with undisputed transaction. Transaction record 705 is associated with a disputed transaction. As shown in FIG. 7, the transaction image associated with transaction record 701 is being used as authenticated image 752. The transaction image associated with transaction record 705 is shown as transaction image 722. It is noted that the transaction images associated with transaction records 702 and 703 can also be used as authenticated image 752. The transaction image associated with transaction record 704 should not be used as authenticated image 752 because it does not shown a clear view of the transaction party.

As shown in transaction detail 700, the transaction party shown in transaction image 722 is not the authorized person shown in authenticated image 752. Accordingly, the transaction in question should be considered illegitimate or fraudulent.

In another aspect, the invention provides a method for resolving such disputes. A dispute resolution network that has exclusive access to visual proof data center 430 can be created to record a dispute (e.g., dispute 454) and to query the actual transaction (e.g., transaction record 412) and the images associated with the dispute (e.g., transaction image 422 and authenticated image 452). The dispute resolution network of the present invention returns a transaction image of the transaction party and an authenticated image of an authorized person (e.g., the customer who filed the dispute) to a customer service representative of the authorized person. The customer service representative uses the transaction image and the authenticated image to definitively settle the dispute with the consumer.

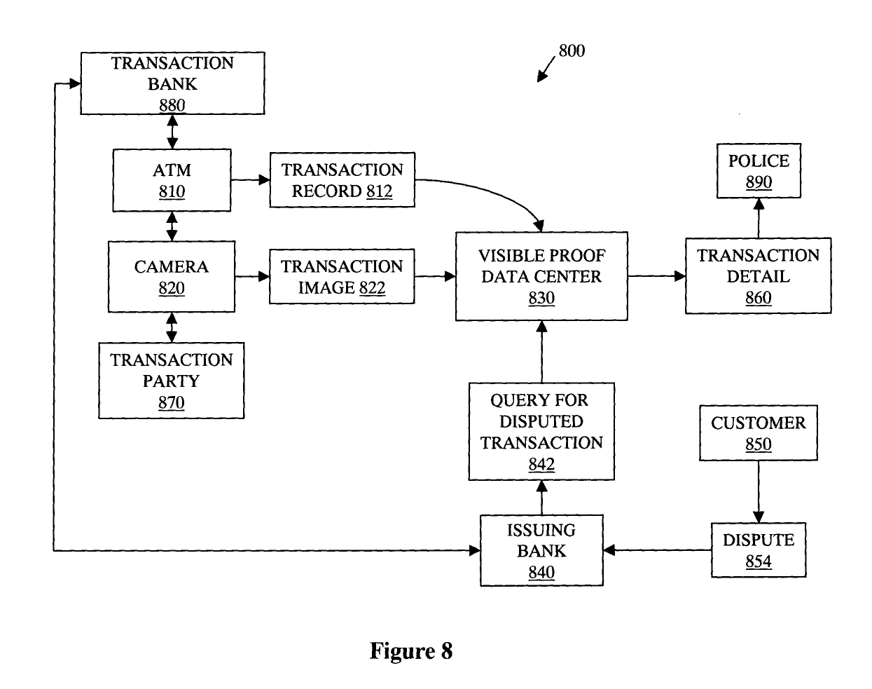

FIG. 8 is a schematic showing an exemplary scenario involved in using an embodiment of the dispute resolution network of the invention.

Customer 850 of issuing bank 840 is the only authorized person to use an ATM card issued by bank 840. Transaction party 870 steals the ATM card and uses the card at ATM 810 of transaction bank 880. ATM 810 authenticates the card and PIN and dispenses the money to transaction party 870 who presented the card. Transaction record 812 or transaction information is processed and stored in both bank 840 and bank 880. Through known banking practices, bank 880 later recovers the cash from the account of customer 850 of bank 840.

Visible proof network 800 of the invention includes camera 820. Camera 820 captures transaction image 822 of transaction party 870 and records transaction reference information for the transaction. On a periodic basis, transaction record 812 and transaction image 822 are sent to visible proof data center 830, which is part of network 800.

Several days later customer 850 receives the periodic statement from bank 840, which shows the withdrawal from ATM 810 of bank 880. Customer 850 initiates disputes 854 challenging the transaction by calling the customer service number on the statement issued by bank 840.

A customer service representative (CSR) of bank 840 uses the dispute resolution network 800 of the invention to record dispute 854 and submit query 842 for the disputed transaction. Dispute 854 is associated with or contains a reference to the transaction of the card of customer 850 at ATM 810.

Prior to the present invention, a conventional system could not visually affirm that customer 850 of bank 840 was actually the one presenting the ATM card at ATM 810 of bank 880. Using the invention, CSR of bank 840 uses dispute resolution network 800 to find the transaction associated with the dispute and transaction image 822 taken by camera 820 at the time of the transaction. The CSR finds the record from a visible proof database of visible proof data center 830, which receives transaction record 812 and transaction image 822 from ATM 810 and camera 820. The CSR requests to see transaction image 822. Since bank 840 and bank 880 already have an agreement in place to share access to transaction image 822 captured by camera 820, network 800 fetches transaction image 822 associated with the disputed transaction from the visible proof database and presents it to the CSR along with an optionally available authenticated, reference image of customer 850. In an alternative embodiment of the present invention, transaction image 822 associated with the disputed transaction is fetched from a centralized video repository.

The CSR compares the authenticated image and transaction image 822 and determines that transaction party 870, the person who presented the card to ATM 810, was not customer 850. The CSR confirms with customer 850 that transaction party 870 is unknown to customer 850 and settles the dispute in favor of customer 850. The CSR may also cancel the card of customer 850 and issue a new ATM card with a different PIN to customer 850.

The CSR can then query customer 850 regarding how transaction party 870 could have obtained the PIN or the card number. Any obtainable facts can then be entered in the system. The CSR can then forward transaction detail 860 associated with the transaction to police 890 to initial a criminal investigation.

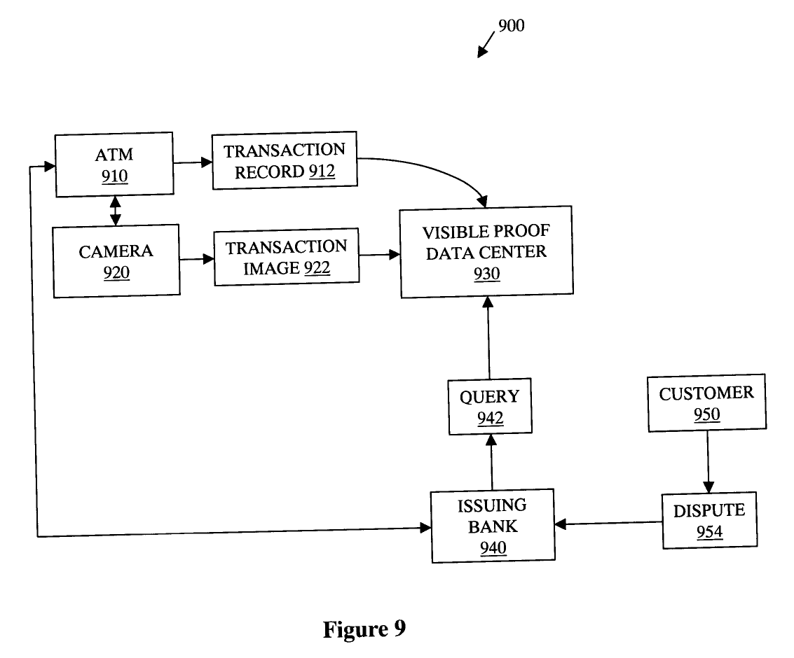

FIG. 9 is a schematic diagram showing an exemplary scenario involved in using another embodiment of the invention.

Customer 950 of bank 940 uses his ATM card to withdraw $ 100 cash from ATM 910 of bank 940 on a very hectic day. Customer 950 throws the ATM receipt away.

Camera 920 coupled to ATM 910 captures an image of customer 950 during the withdrawal of the cash from ATM 910 and associates image 922 with transaction record 912 of the withdrawal. On a periodic basis, bank 940 sends transaction record 912 and transaction image 922 to visible proof data center 930.

Fifty days after receiving the periodic statement from bank 940, customer 950 finally looks at his statement and tries to reconcile his account. He notices the $ 100 has been withdrawn from ATM 910. He does not remember making the withdrawal and decides to dispute the transaction. He calls the CSR of bank 940 to register his dispute 954. The CSR of bank 940 records dispute 954 and the referenced transaction. The CSR of bank 940 uses dispute resolution network 900 of the invention to find the disputed transaction at ATM 910 and requests, in query 942, transaction image 922 associated with the transaction. Dispute resolution network 900 retrieves transaction image 922 associated with the transaction and an authenticated picture of customer 950. The CSR of bank 940 reviews transaction image 922 and the authenticated picture. Transaction image 922 clearly shows customer 950 withdrawing the cash from ATM 910. The CSR describes to customer 950 what he was wearing when he withdrew the money from ATM 910 and offers to send an e-mail of transaction image 922 to customer 950. Customer 950 is reminded of the transaction and agrees with the CSR that dispute 954 should be settled in favor bank 940.

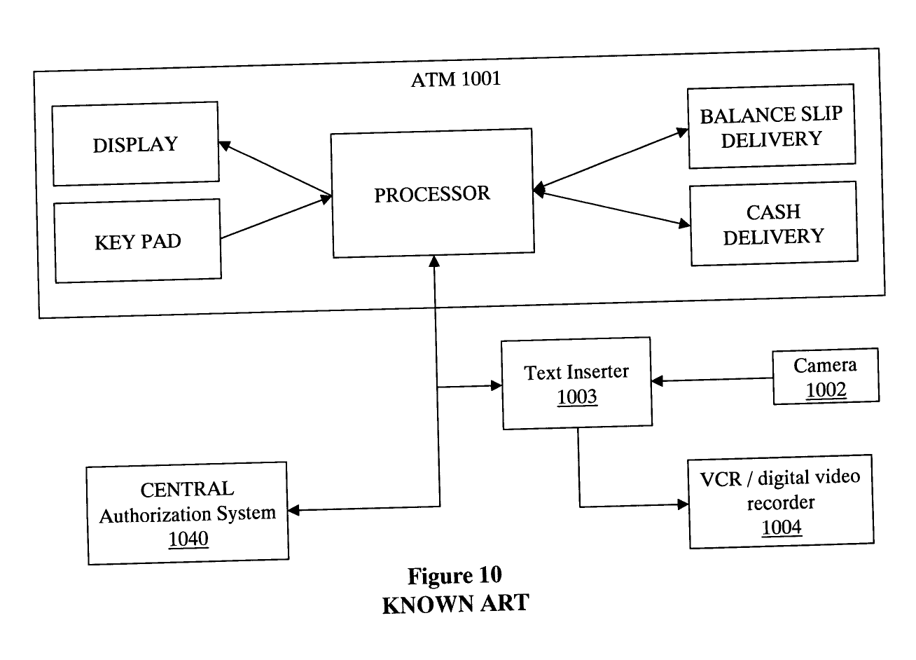

FIG. 10 illustrates the current state of the art in integrating transaction information with images (e.g., video) at a known ATM. ATM 1001 is the ATM as described in U.S. Pat. No. 4,134,537. Camera 1002 is an analog camera that is installed within ATM 1001 to capture an image of a consumer (a transaction party) who uses ATM 1001. Text inserter 1003 is a device that can be obtained from, e.g., Transaction Verification System (“TVS”) and American Video Equipment (“AVE”). Text inserter 1003 takes the ATM machine serial transaction output, converts it to text, and overlays the text on to the video signal coming from camera 1002. Text inserter 1003 then outputs the combined video for recording on to local video cassette recorder (VCR) 1004 or a digital video recording device. Central authorization system 1040 is the central authorization system of the existing ATM network. The current state of the art does not allow for remote centralized retrieval of the video information nor does it allow for the association of the transactional data with the video. Typically, the recorded videotapes or files stay at the ATM location. If the tapes are moved to a centralized location, then the tapes must be manually cataloged and stored.

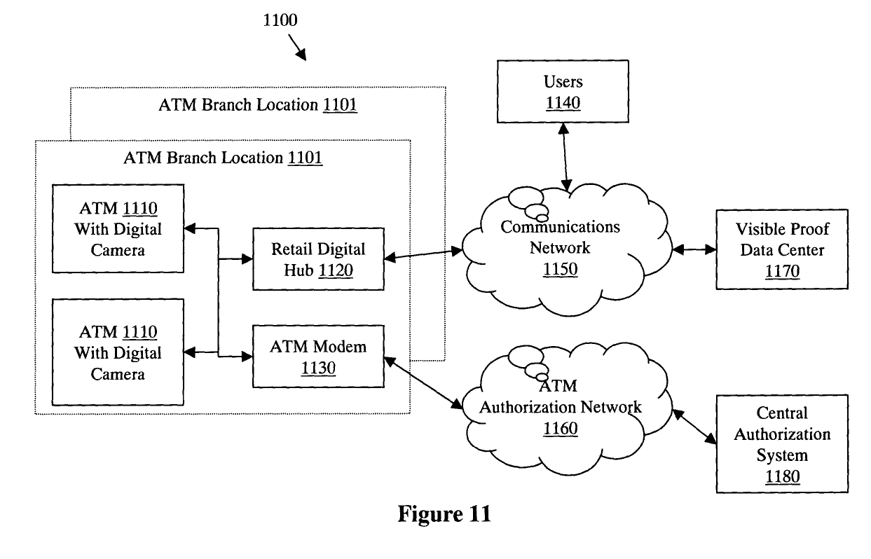

FIG. 11 is a schematic diagram showing how a visible proof data center of the invention relate to existing components of an ATM system. A preferred embodiment of the invention is directed to integrating an ATM as the input source of both transactional and video data into a digital video repository. The repository stores the ATM's transaction information in a database with a cross reference from the transaction record to the ATM's video record of the event. The repository can be queried by the financial institutions through either a web browser or an other client software to settle disputes with the ATM consumer by verifying the identity of the individual interacting with the ATM at the time of the transaction.

As shown in FIG. 11, system 1100 of the invention includes visible proof data center 1170. Data center 1170 is configured to be in communication with communications network 1150. Communications network 1150 can be, for example, the Internet, a virtual private network (VPN), or the like. Through communications network 1150, visible proof data center 1170 can communicate with ATM branch locations 1101. Each ATM branch location 1101 includes one or more ATM 1110. ATM 1110 preferably includes a digital camera. ATM 1110 is coupled to retail digital hub 1120 and ATM modem 1130. ATM authorization network 1160 is a known system for ATM transactions. ATM authorization networks 1160 is in communication with central authorization system 1180. Users 1140 can verify legitimacy of transactions associated with ATM 1110 via communications network 1150. Users 1140 can include, for example, banks, credit card issuers, debit card issuers, other financial institutions, and the like. Users 1140, via communications network 1150, can access information stored in visible proof data center 1170 of the invention. In this embodiment, it is noted that one of the major differences between the invention and prior art is the centralization of the transactional and video data, i.e., moving the data out of ATM locations 1101 and the treatment of ATM video as information as oppose to stagnant tapes.

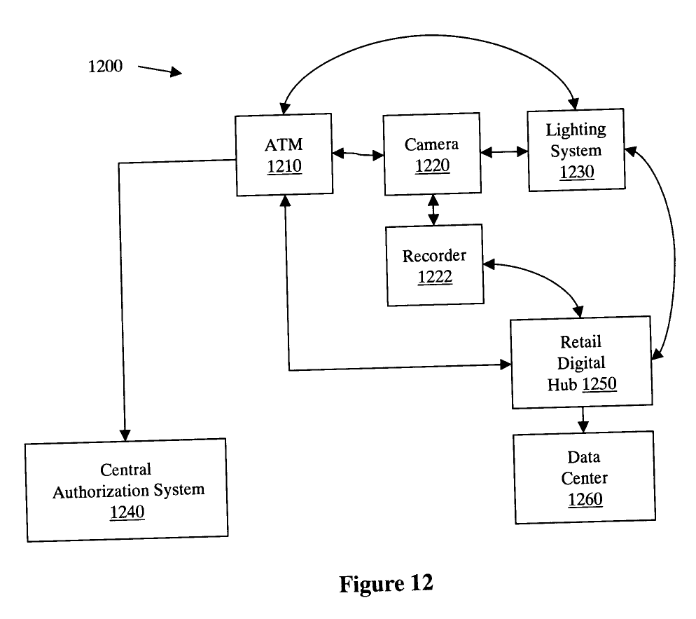

FIG. 12 is a schematic diagram showing the system of an embodiment of the present invention. System 1200 includes ATM 1210, camera 1220, recorder 1222, optional lighting system 1230, central authorization system 1240, retail digital hub 1250, and data center 1260.

The interface between an ATM video verification system and the traditional ATM system is either a Y-cable splitting off the serial communications from the ATM to central authorization system 1240 or an Ethernet connection locally. The ATM video verification system is designed to not alter the current behavior of the ATM processing flow.

ATM 1210 is a known automated teller machine. Camera 1220 is preferably a digital video camera recorder coupled with a transmitter. An example of a currently-available product that can be used as camera 1220 is the IDNC device of the ComCam International. Video or images captured by camera 1220 is transmitted to retail digital hub 1250 for processing. Combined transaction information and video (transaction image) are transmitted to data center 1260 for storage and retrieval.

In a different implementation of the invention, camera 1220 can be an analog camera. The analog camera preferably has a digital CCD device in it. The output of the analog camera is an analog video signal, which is typically transmitted over a thin coax cable. If an analog camera is used, recorder 1222 can be coupled to one of camera 1220 and retail regional hub 1250 to enable processing of the analog video signal produced by camera 1220. A known product that can be used as recorder 1222 is the IDNC-10 device of ComCam International.

If recorder 1222 is coupled to retail digital hub 1250, retail digital hub 1250 digitizes the ATM transaction video signal, compresses it for storage, and transmits the combined information to data center 1260 for storage and retrieval.

Optional lighting system 1230 ensures that a transaction party conducting a transaction at ATM 1210 is properly illuminated when camera 1220 is operating. Preferably, optional lighting system 1230 is coupled to camera 1220 to optimize the timing of lighting system 1230 and camera 1220.

Retail digital hub 1250 interprets and records the ATM transaction data, stores the ATM transaction video, and transmits the combined information to data center 1260 for storage and retrieval.

Central authorization system 1240 provides authorization for transactions that take place at ATM 1210.

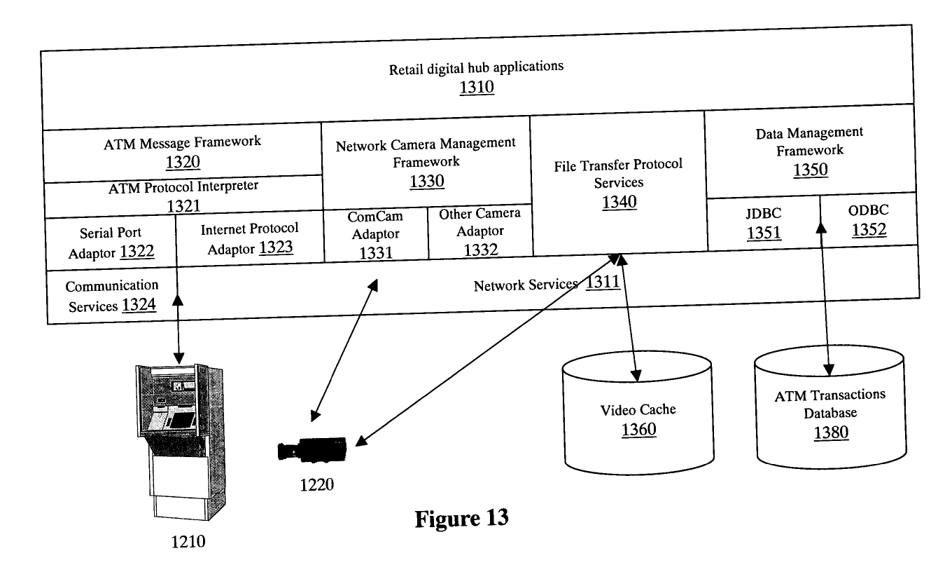

FIG. 13 illustrates the relationships between the possible frameworks (e.g., libraries) necessary to support the suite of applications 1310 of retail digital hub 1250 that works with cameras with built-in recording capabilities according to an embodiment of the present invention. Operating systems that can be used to support applications 1310 can be any of the major modem operating systems, e.g., Microsoft Windows, Unix, Linux, Mac OS X or the like.

ATM 1210 is coupled with camera 1220. Camera 1220 is preferably a network digital camera recorder. An exemplary camera 1220 is the ComCam International IDNC-10 with Lens. If camera 1220 is an analog camera, it can be coupled to a network digital video recorder (not shown). An exemplary network digital video recorder is the ComCam International IDNC-10 device with BNC-in. This device coupled with the analog camera would essentially behave similarly to a digital network video camera. Although only one ATM 1210 and camera 1220 are depicted in FIG. 13, it is understood that an embodiment of the invention can include multiple ATMs 1210 and multiple cameras 1220.

Retail digital hub applications 1310 includes a collection of applications that are necessary to manage interaction between ATM 1210, camera 1220, video cache 1360, ATM transactions database 1380, and data center 1260. Applications 1310 can be written in any of the modern programming languages, e.g., Java, C++, C#, Visual Basic, or the like.

Retail digital hub applications 1310 includes ATM message framework 1320, network camera management framework 1330, file transfer protocol services 1340, and data management framework 1350.

ATM message framework 1320 abstracts and encapsulates ATM related objects with a generic interface for retail digital hub applications 1310. In this way, retail digital hub applications 1310 is isolated from the details of the ATM message and protocol. ATM protocol interpreter 1321 interprets and encapsulates the ATM messages from either serial adaptor 1322 or Internet protocol adaptor 1323. Serial port adaptor 1322 is a group of programs that manage the serial port communications from ATM 1210. The operating system or device specific serial communication services 1324 handles the hardware level interactions with the serial port. Internet protocol adaptor 1323 is a group of programs that manage the Ethernet communications from ATM 1210.

Network camera management framework 1330 is a abstraction layer for generically handling the management of the network digital video cameras 1220. This allows retail digital hub applications 1310 to only deal with this framework and be shielded from the lower level details of the individual adaptors. ComCam adaptor 1331 is a library of programs for communicating with the ComCam IDNC or like network digital video cameras. Other camera adaptors 1332 include like libraries from other network digital video camera manufacturers to manage cameras other than those supplied by ComCam.

File transfer protocol (FTP) services 1340 or some other similar capabilities are used to receive video files from network cameras 1220.

Data management framework 1350 is a library of programs that provide an abstraction layer above the database specific access libraries. JDBC libraries 1351 enables Java applications to communicate with commercial database management systems. ODBC libraries 1352 enables Microsoft Windows applications to communicate with commercial database management systems.

ATM transaction video cache 1360 is where the ATM video (e.g., transaction images) can be stored on the file system for later retrieval and transmission to data center 1260. This cache may be directly on the file system or in a database, e.g., Oracle, Sybase, SQL Server, OpenBase, etc. ATM transaction database 1380 is where the ATM transactions (e.g., transaction information) are stored.

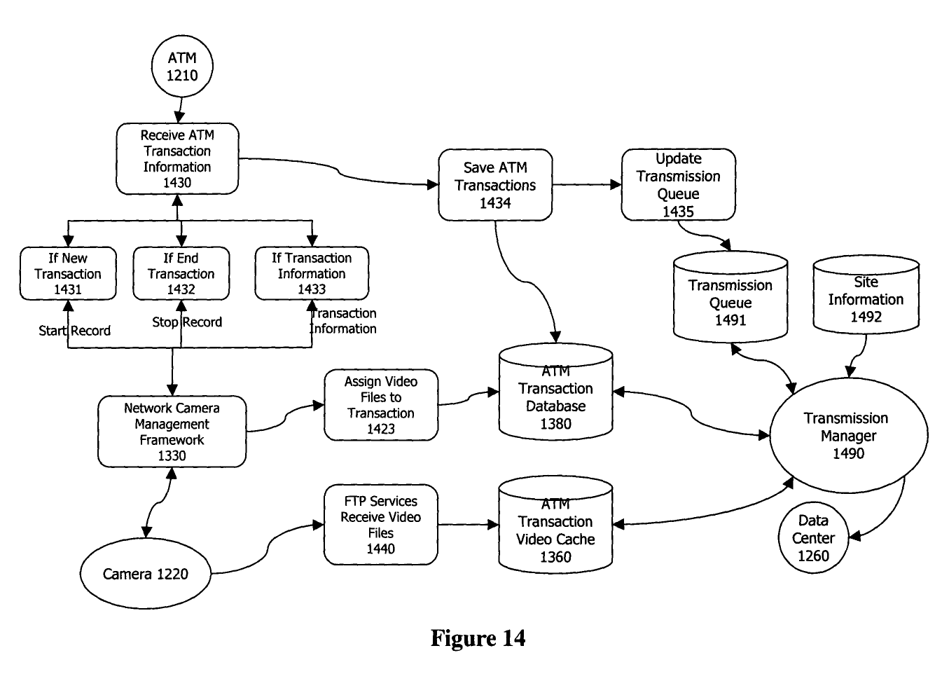

FIG. 14 illustrates the data flow within retail digital hub 1250 as it processes ATM transactional data from ATM 1210 and the video data from camera 1220 for transmission to data center 1260 according to an embodiment of the present invention.

Camera 1220 is coupled with ATM 1210 to capture transaction images associated with transactions conducted at ATM 1210. In step 1430, following an ATM transaction, network camera management framework 1330 receives the ATM transaction information associated with the transaction. If the data packet is at the beginning of the ATM transaction 1431, then network camera management framework 1330 sends a signal to camera 1420 to start recording the event with a few seconds of pre-event frames. If the data packet is the end of an ATM transaction 1432, then network camera management framework 1330 sends a signal to camera 1420 to stop recording. If the ATM transaction packet is that of the transaction itself 1433, then network camera management framework 1330 formats the transaction information and sends the transaction information to camera 1220 so the information can be superimposed on the video.

ATM transaction database 1380 can be used to save the transaction information in state 1434. ATM transaction database 1380 can also be used to save any associated records.

At this time, since the transaction record is newly created (it has not been sent to data center 1260), the Transmission indicator is set to NOTSENT. This can be done in step 1435. Transmission queue 1491 is where an indicator is set to signify the ATM transaction has not been sent to data center 1260. Once transmission manager 1490 has sent the ATM transaction record to data center 1260, then the indicator is set to SENT and the data and time of transmission are also set.

To associate the video file recorded by camera 1220, the filename that was created by camera 1220 needs to be assigned to the ATM transaction record in step 1423. This process updates ATM transaction database 1380 with the video filename. ATM transaction database 1380 is where all ATM transactions are stored.

The FTP or some other file transfer protocol may be used in step 1440 to receive the video file from camera 1220 and store the video file on the file system. If necessary, the protocol may be used to process the video file and store the video file in ATM transaction video cache 1360. ATM transaction video cache 1360 is where the ATM video is stored on the file system for later retrieval and transmission to data center 1260. This cache may be stored directly on the file system or in a database, e.g., Oracle, Sybase, SQL Server, OpenBase, and the like.

Site information 1492 is where attributes associated with this installation are stored, e.g., Host IP, Customer ID, etc.

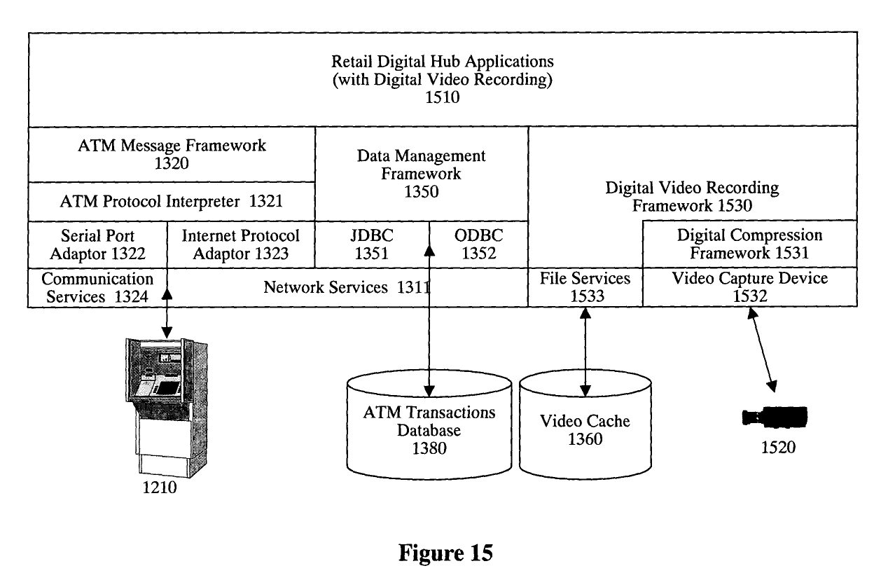

FIG. 15 illustrates the relationships between the possible frameworks (libraries) necessary to support the suite of applications 1510 of retail digital hub 1250 that includes a built-in digital video recorder and works with traditional analog video cameras according to an embodiment of the present invention. Operating systems that can be used to support applications 1510 can be any of the major modern operating systems, e.g., Microsoft Windows, Unix, Linux, Mac OS X, or the like.

Retail digital hub applications 1510 includes a collection of applications that are necessary to manage interaction between ATM 1210, camera 1520, video cache 1360, ATM transactions database 1380, and data center 1260. Applications 1510 can be written in any of the modern programming languages, e.g., Java, C++, C#, Visual Basic, or the like. The embodiment shown in FIG. 15 differs from that illustrated in FIG. 13 in that applications 1510 incorporates the video capture capabilities that is associated with camera 1220 of FIG. 13.

Retail digital hub applications 1510 includes ATM message framework 1320, data management framework 1350, and digital video recording framework 1530. ATM message framework 1320 and data management framework 1350, and their associated components, are similar to those described above for FIG. 13.

Digital video recording framework 1530 processes the requests from the applications to start and stop recording, takes the ATM transaction information, embeds the data into the video frames, sets the video capture rate, and stores the video on the file system. The functions mentioned here are a subset of the features typically available in digital video recorders, including those available from General Solutions, Pelco, Ultrax, etc.

Video compression framework 1531 may be software or hardware based. Video compression framework 1531 can apply one of many available digital video compression algorithms, e.g., MJPEG, WAVLET, MPEG-4, H263 and the like to the captured video to decrease the storage/transmission requirements.

Video capture device 1532 can be a hardware device with a digital capture chip, e.g., BT878 or ADV611, that accepts analog video input and converts it to a digital format so the computer can process it.

Once the video has been captured, encoded, and superimposed with the ATM transaction information, the video files can be stored using file services 1533. The video files can be stored in the file system. For example, the files can be stored in a database. Video cache 1360 can be used to store the files.

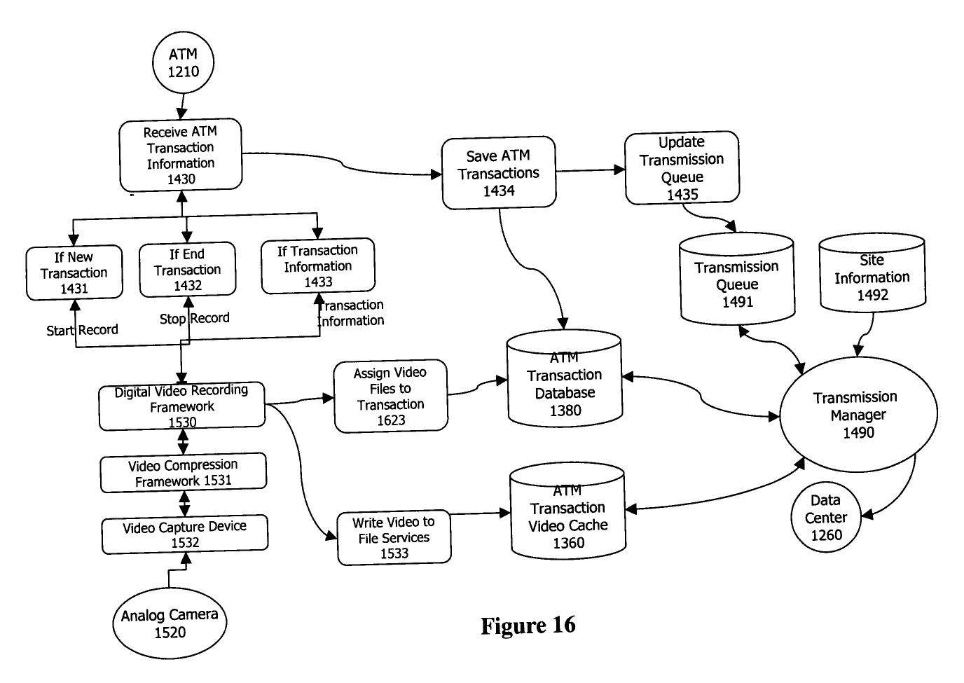

FIG. 16 illustrates the data flow within retail digital hub 1250 as it processes ATM transactional data from ATM 1210 and video from camera 1520 for transmission to data center 1260 according to an embodiment of the present invention. As discussed in conjunction with FIG. 15, camera 1520 is an analog camera.

Through camera 1520, video capture device 1532, video compression framework 1531, and digital video recording framework 1530, video captured by camera 1520 can be assigned to transaction in step 1623. In addition, the video captured can be transferred via file services 1533 to video cache 1360. Other components shown in FIG. 16 work similarly as described above in FIG. 14.

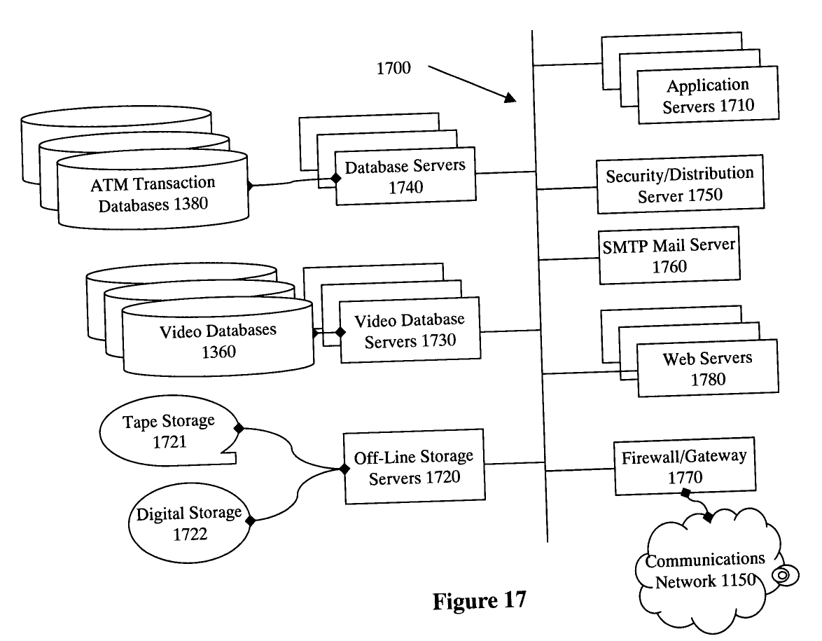

FIG. 17 illustrates the multi-tier relationship between the various systems in the data center 1260 to deal with the massive amounts of both transactional and video data according to an embodiment of the present invention.

Local area network 1700 is preferably based on TCP/IP protocol, preferably at greater than 100 mbps. Through gateway 1770, data center 1260 can communicate with communications network 1150. Communications network 1150 can be the Internet or a virtual private network as described above.

One or more application servers 1710 are where the visible proof, visible evidence portals, and the batch programs of the invention reside.

One or more off-line storage servers 1720 can be used to manage the tape storage 1721 and digital storage 1722 to archive the video and data files, respectively. Tape storage 1721 can include one or more of tape silos and tape cartridges. Digital storage 1722 can include, e.g., DVD, CD-R media, DVD-writing devices, and CD-writing devices.

One or more video database servers 1730 can be used to manage the vast quantities of video files in the system, which are stored in one or more video databases (or video caches) 1360. Video databases 1360 can include any appropriate disk storage devices that can store video files.

One or more database servers 1740 are the database management system that can operates to manage the database files stored in ATM transaction databases 1380. The database files can be either relational or object-oriented. ATM transaction databases 1380 can include any appropriate disk storage devices that can store database files.

Security or distribution server 1750 can be used to validate the customer login and then route them to their application servers.

SMTP server 1760 can be used to send electronic messages from the system to the customers.

Gateway and firewall 1770 is used to protect data center 1260 from unwanted access including cyber-attacks.

One or more web servers 1780 can be used to manage the HTTP transmissions to the customers.

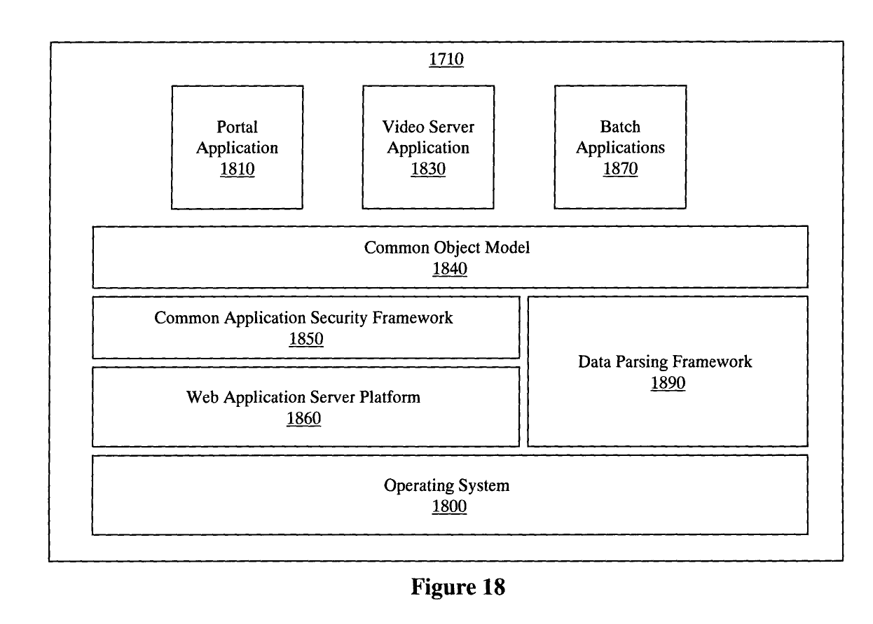

FIG. 18 illustrates the architecture of application servers 1710 according to an embodiment of the present invention. Application services 1710 includes operating system 1800, portal application 1810, video server application 1830, batch applications 1870, common object model 1840, common application security framework 1850, web application server platform 1860, and data parsing framework 1890.

Operating system 1800 can be a generally available server operating system, e.g., Apple OS, X Server, IBM AUX, Sun Solaris, Redhat, Linux or the like.

Portal application 1810 can be written in either the Java or Java like programming languages of the available web application platforms, e.g., Apple's WebObjects, BEA's WebLogic, IBM's WebSphere, JSP, J2EE, Microsoft ASP, and the like. Portal application 1810 manages the interaction between financial institutions, e.g., banks, credit card issuers, debit card issuers, and the ATM transaction information stored in data center 1260. Once the financial institution users have identified the ATM transaction information that they would like to review, portal application 1810 interacts with video database servers 1730 to stream the video to the user at the financial institution.

Video server application 1830 is responsible for sending the requested video stream to portal application 1810, decoding of the video files for the transmission, and managing the video streams to the appropriate visible proof/evidence session.

Common object model 1840 is the common object model for portal application 1810. Common object model 1840 manages the translation of relational data into the run-time object model.

Common application security framework 1850 is the common application security framework.

Web application server platform 1860 can be, e.g., Apple's WebObjects, IBM's WeSphere, BEA's WebLogic, JSP, Microsoft ASP, and the like.

Batch application 1870 may reside on their own batch application servers.

Data parsing framework 1890 is a group of low level programs that systematically parse the textual data files that are being transmitted to data center 1260.

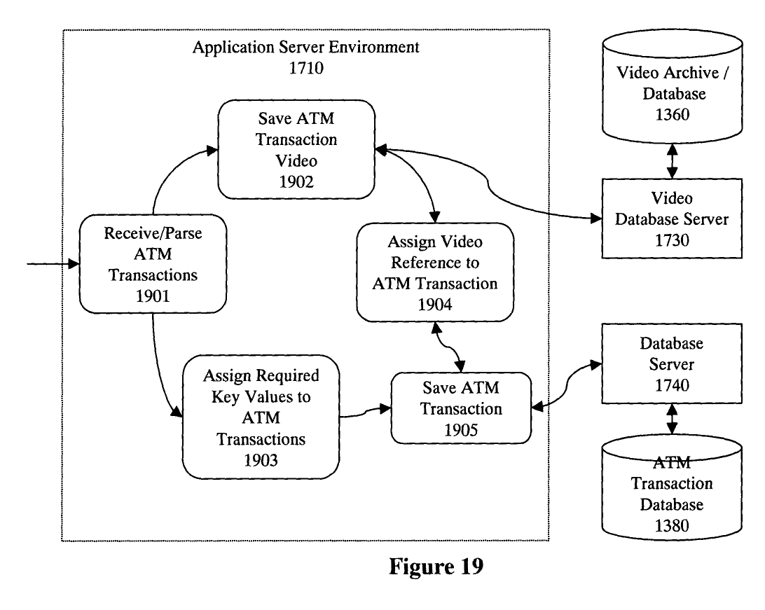

FIG. 19 illustrates major processes on batch applications 1870 to process the incoming video and encoded transactions from ATMs according to an embodiment of the present invention.

The environment of application server 1710 include steps 1901, 1902, 1903, 1904, and 1905.

In step 1901, application server 1710 receives and parses the ATM video and transaction data.

In step 1902, application server 1710 saves the ATM transaction video to video database (or archive) 1360 via video database server 1730, and sends the reference information of the videos to step 1904.

In step 1903, application server 1710 assigns any additional required key values to the ATM transactions that were not assigned by retail digital hub 1250.

In step 1904, application server 1710 assigns video reference data to the ATM transaction, so the two types of information are associated with either other.

In step 1905, application server 1710 saves the ATM transactions to ATM transaction database 1380 via database server 1740.

Video database server 1730 may be the same as database server 1740. For clarity purposes, servers 1730 and 1740 are shown as two separate database servers. Database server 1740 can be those available from, for example, Oracle, Sybase, OpenBase, MySQL, DB2, and the like.

The video may be stored in video archive or database 1360 on the file system depending on the implementation requirements.

ATM transaction database 1380 contains the collection of tables necessary to support this application.

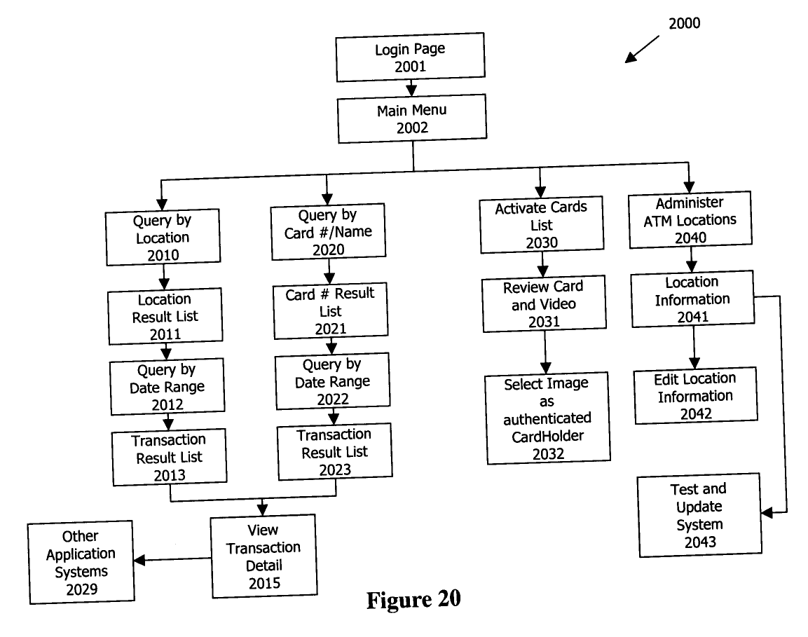

FIG. 20 illustrates an exemplary structure of a visible proof ATM application portal of the invention. Portal 2000 can be used by a financial institution to access ATM transactions and the associated video from its web-browser (or other means). This application could also be implemented using the client server architecture. This application can be integrated with one or more other applications, e.g., claims processing, dispute resolution, and criminal investigation.

Login page 2001 is the main login page for the financial institution. A user can be authenticated using appropriate security algorithms. For example, a userID and a password must be submitted by the user to access portal 2000.

Main menu 2002 is the main menu page of the system. The user can access other pages of the system starting with main menu 2002. For example, from main menu 2002, the user can access one or more of pages 2010, 2020, 2030, and 2040.

Page 2010 is a “Query ATM Transactions by Location” page. Page 2010 is where the customer can query for the list of ATM locations registered in the system. Location query result list page 2011 is where a list of locations matching the query parameters are displayed. The user can select the location of interest and query for the list of transactions at that location in page 2012. For example, in page 2012, the user can query by date range for a selected location. To do so, the user enters a date or a date range of interest to retrieve the appropriate information. The results of the query is listed in page 2013. Using page 2013, the location and date range query result list, the user can see the list of ATM transactions that may be sorted by any of the column headings, e.g., sequence number, card number, date/time of the transaction, dollar amount, etc. The user can select any one of the transactions and view the details of each transaction and the associated video. Thumb-nails may also be displayed on page 2013 with each of the transactions.

Page 2015 is the “View ATM Transaction Detail” page. Page 2015 shows the details of the ATM transaction and its associated video. FIGS. 5 and 6 are two exemplary pages 2015. From page 2015, the user can proceed to other information systems on page 2029. Page 2029 can lead the user to find other information processing systems that may be interfaced with this application, where visible proof of a transaction party making the transaction can be helpful in settling the authentication issue.

Page 2020 is a “Query ATM Transaction by Card Number or Cardholder Name” page. Through page 2020, the user can query for the list of ATM cards registered in the system.

Page 2021, the “Card Number or Cardholder Query Results” page, is where a list of ATM cards matching the query parameters is displayed. The user can select the card of interest and query for the list of transactions for that card in page 2022.

Page 2022 is the “Query by Date Range” page for a selected card. The user enters a date or date range of interest to retrieve for the desired results. The results of the query is listed on page 2023.

Page 2023 is the “Card and Date Range Query Result” list. FIG. 7 is as an exemplary page 2023. On page 2023, the user can see the list of ATM transactions that may be sorted by any of the column headings, e.g., financial institution, transaction date and time, ATM location, transaction sequence number, transaction time, amount, etc. The customer can select any one of the transactions and view the details of this transaction and the associated video. As shown in FIG. 7, a thumbnail image may be displayed on page 2023 for each of the transactions.

Page 2030 is the “Activate Cards List” page. On page 2030, the user can activate one or more new cards that have been assigned to the user. Page 2030 can also be used to display a list of cards that have been activated and assigned to this user. The user can work through each of the transactions associated with the cards using pages 2031 and 2032 to select an image as the authenticated image for the user's card or cards. The image selected can be one that was captured during the initial activation process (the activation image) or one that was captured during an undisputed transaction (the transaction image).

For example, on page 2031, the “Review Card and Video” page, the user (or another person such as a financial institution representative) can review one or more activation images and undisputed transaction images associated with the user's card to select one to serve as the authenticated image. Not all transaction and activation images is suitable for use as the authenticated image because a transaction party may move around in front of the camera during the activation activity. Accordingly, it may not be advisable for the system to automatically assign a particular image from the video file to be the best image of this particular user. Accordingly, it is preferably that human heuristics be depended upon, to some extent, to select the best image. Thus, the user can review each frame captured by the system during the activation process and assign the best picture to his or her cards. It is contemplated that as biometrics technology improves, the invention can be modified to utilize biometrics to select the best image.

On page 2032, the user selects the best image as the authenticated cardholder image. Here, the system can convert an video image into a still image, e.g., JPEG or another compressed format. The system can then store an association between the still image file and the cardholder record in the database.

Page 2040 represents the “Administer ATM Locations” menu page. A system administrator can use this page to configure the ATM location information and ATM digital retail hub.

Page 2041 is where the administrator can review current ATM information.

On page 2042, the administrator can edit the ATM information stored in the data center and replicate the information to the ATM retail digital hub.

The administrator can use page 2043 to test and update the remote systems. Page 2043 preferably runs diagnostics programs in the retail digital hub and the digital video camera from the data center.

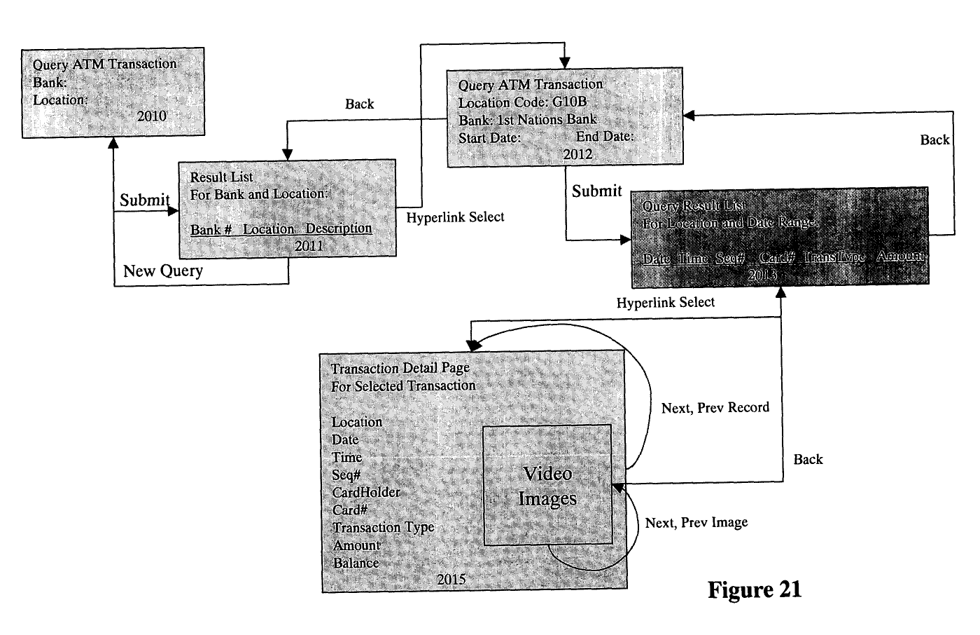

FIG. 21 is a more detailed illustration of the sequence of screens/pages 2010, 2011, 2012, 2013, and 2015 according to an embodiment of the present invention.

As shown on page 2010, the user can query for the list of ATM locations registered in the system. In an exemplary implementation, the user can input a name of a bank or a location associated with the bank to query transactions associated with ATMs of the bank. For example, the input can be “First City Bank” and the location can be the name of the city and stat of the bank.

On page 2011, a list of locations matching the query parameters is displayed. The user can select the location of interest and query for the list of transactions at that location in page 2012. If none of the locations meets the user's expectation, the user can return to page 2010 and submit a new query.

On page 2012, the user enters a date or a date range of interest to retrieve information. For example, the user can enter “Jan. 1, 2003,” as the start date, and “Jan. 15, 2003,” as the end date. Preferably, the user can return to page 2011 to select a different location.

After the user submits the query, page 2013 is displayed. In an exemplary implementation of the invention, the user sees a list of ATM transactions that may be sorted by any of the column headings. The column headings can include one or more of, for example, date, time, sequence number, card number, transaction type, dollar amount, etc. Preferably, the user can further select any one of the transactions and view the details of the selected transaction and its associated video or images. Thumb-nails may also be displayed here with each of the transactions. If none of the transactions is of interest, the user can return to page 2012 and submit a different query. If any one of the transactions is selected, the transaction details associated with that transaction is displayed on page 2015.

Page 2015 is where the details of the ATM transaction and its video for the selected ATM transaction can be reviewed. The user can flow from page 2015 to other information systems in 2029 where other business processes can be completed. On page 2015, adjacent (i.e., next or previous) records can be retrieved by clicking an appropriate button. Similarly, next or previous image can be retrieved by clicking an appropriate button.

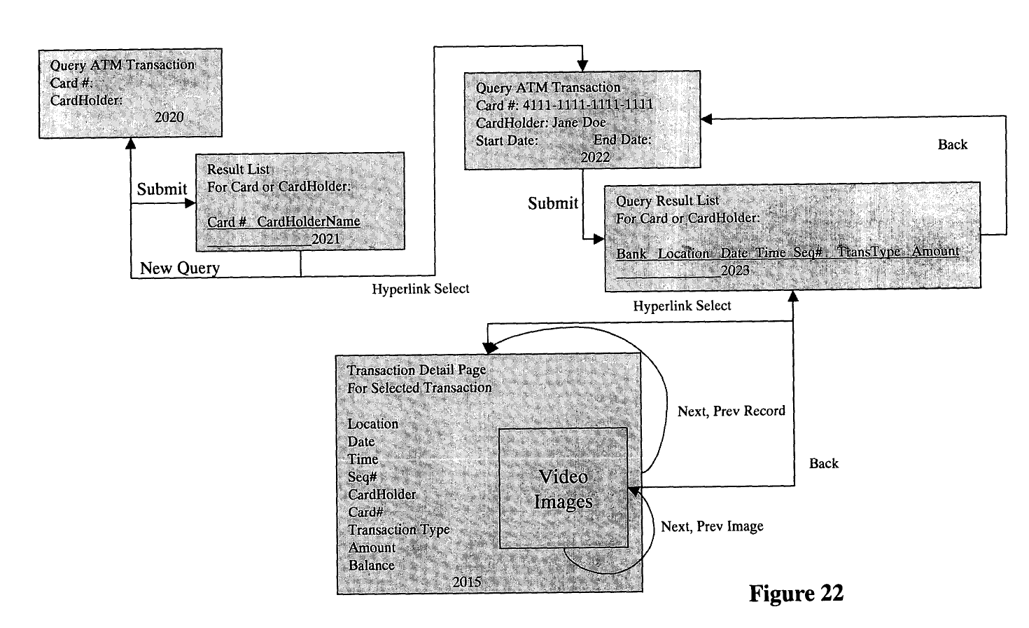

FIG. 22 is a more detailed illustration of the sequence of screens/pages 2020, 2021, 2022, 2023, and 2015 according to an embodiment of the present invention.

Using page 2020, the user can input appropriate information (e.g., a cardholder's name or a card number) to query for transactions associated with that cardholder or card. For example, on page 2020, the user can input “Jane Doe,” the name of a cardholder.

Page 2021 is where a list of ATM cards matching the query parameters is displayed. For example, Jane Doe may have one or more cards. One of those cards has the number of “4111-1111-1111-1111.” The user can select the card of interest and query for the list of transactions for that card on page 2022. If none of the cards meets the expectation, the user can return to page 2020 to submit a new query.

If the user selected card “4111-1111-1111-1111” on page 2021, the user is prompted to enter a date range on page 2022. Here, the user enters a date or date range of interest to retrieve appropriate transactions.

On page 2023 the user sees a list of ATM transactions that may be sorted by any of the column headings. For example, the transactions that occurred within the date range for that card can be sorted by, e.g., bank, location, date/time, sequence number, transaction type, dollar amount, etc. The user can select any one of the transactions and view the details of the selected transaction and the associated video on page 2023. Thumb-nails may also be displayed here with each of the transactions. If no transaction is found or the query did not yield the expected results, the user can return to page 2022 and submit a new query with a new date range.

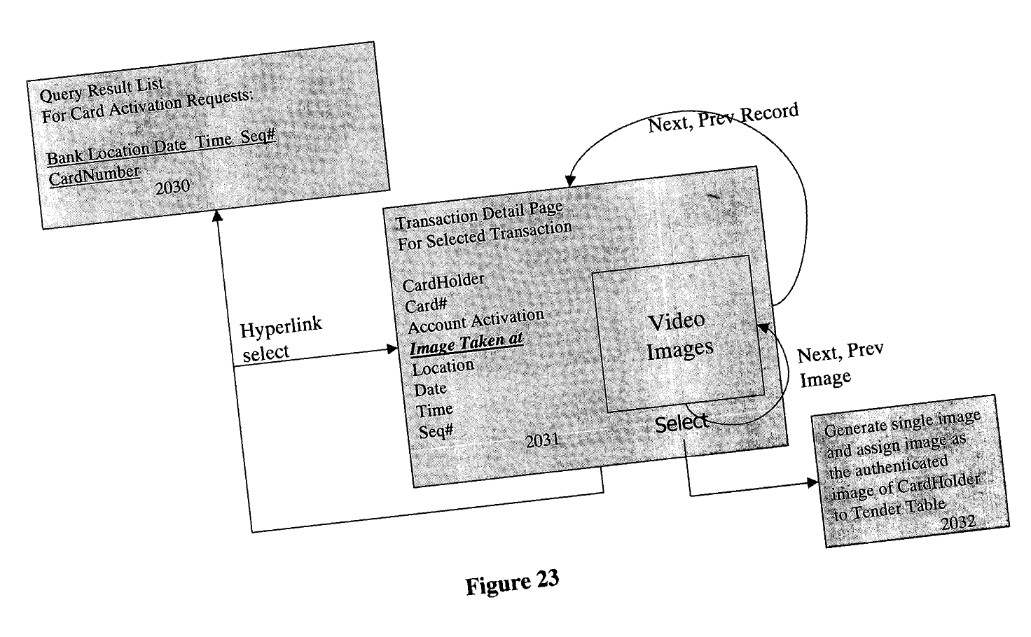

FIG. 23 is a more detailed illustration of the sequence of screens/pages 2030, 2031, and 2032 according to an embodiment of the present invention. A card issuer (or a user/cardholder) can select images recorded by a system of the invention during the card activation process as the authenticated image of the cardholder associated with this card/account.

When a user enters or accesses page 2030, a list of transactions associated with cards that have been activated and assigned to this user is displayed. For example, the transactions can include transaction information such as name of bank, location, date/time, sequence number, and card number. The user can then work through each of these transactions using pages 2031 and 2032 to select the “best picture” for use as the authenticated image.

After one of the transactions is selected on page 2030, the process goes to page 2031, which is the Review Card and Video page. On page 2031, transaction details associated with the transaction, including video images, are displayed. Because the user or cardholder may move around in front of the camera during the activation activity, the system may not be able to automatically assign a particular image from the video file to be used as the best image of this particular cardholder. Page 2031 permits a user of the invention to select the best image from the video file. For example, the user can review each frame captured by the system during the activation process and assign the best picture to this account.

On page 2032, the selected video image is converted into a single image, which is now considered to be the authenticated image. The single image can be, e.g., a JPEG or another compressed format. The authenticated image is then associated with and the cardholder record in the database.

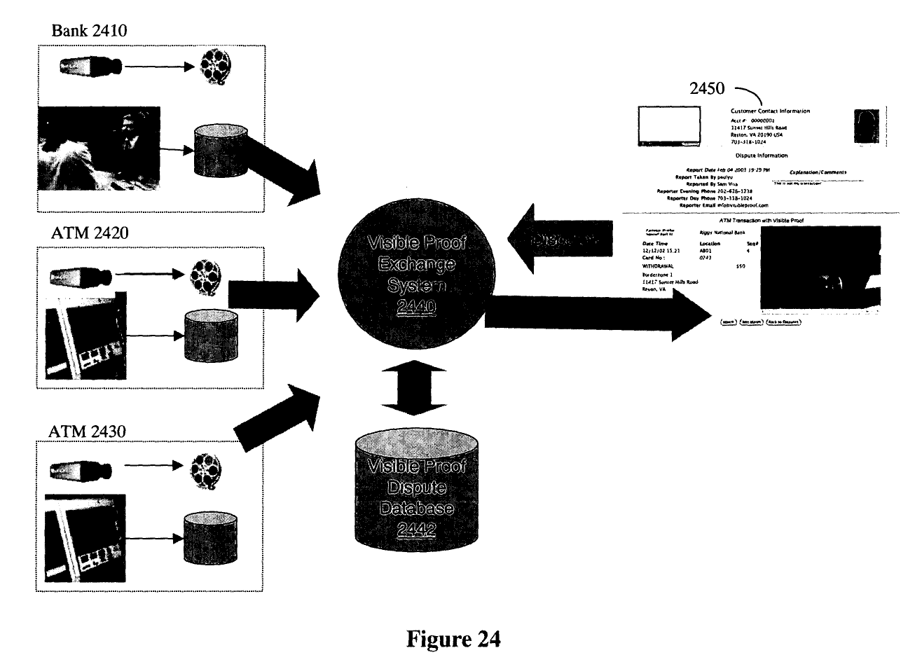

FIG. 24 is a schematic diagram showing the data flow associated with a preferred embodiment of the invention. At bank 2410, an authenticated image of an ATM cardholder is captured. The authenticated image can be stored locally in a database at bank 2410. The authenticated image can also be provided to visible proof exchange system 2440 of the invention. For example, the authenticated image can be stored at visible proof dispute database 2442 associated with visible proof exchange system 2440.

ATM 2420 and ATM 2430 are two ATMs associated with bank 2410. ATM cards issued by bank 2410 can be use to make transactions at either ATM 2420 or ATM 2430. For example, ATM 2420 may be owned and operated by bank 2410, and ATM 2430 is an ATM owned and operated by a different bank but is sharing the same ATM network. When transactions are conducted at ATM 2420 and ATM 2430, transaction image and transaction information are generated. The transaction image and transaction information can be locally stored at each ATM. The transaction image and transaction information can also be stored in visible proof dispute database 2442 of visible proof exchange system 2440.

When a customer files a dispute with visible exchange system 2440, the authenticated image, the transaction image, and the transaction information can be retrieved and studied. Preferably, the authenticated image, the transaction image, and the transaction information can be gathered and presented on dispute resolution page 2450.

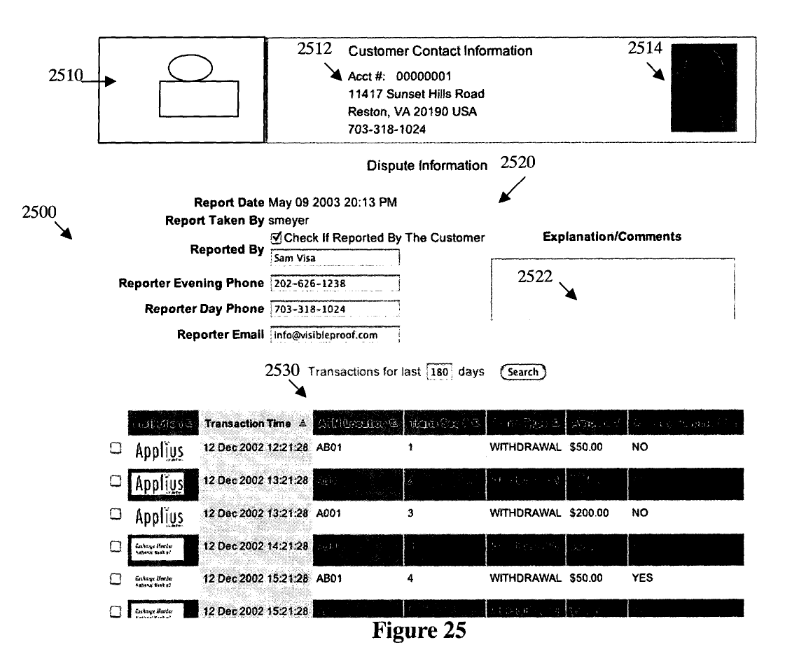

FIG. 25 is an exemplary report that can be generated by visible proof exchange system 2440 of the invention. Report 2500 includes a number of elements. Image 2510 can be an image of the ATM card, which shows the name of the ATM card issuer, the card number, expiration date, and name of the ATM cardholder. Field 2512 provides customer contact information. For example, field 2512 can be used to display the account number, address of the cardholder, and his telephone number. Authenticated image 2514 can be a photograph taken by the ATM card issuer at the time the cardholder is approved to use the ATM card. It is noted that authenticated image can be a transaction image associated with an undisputed transaction. For example, a transaction image associated with a verified, legitimate transaction previously conducted by an authorized person can be used as authenticated image 2514.

Visible proof exchange system 2440 can be operated by a customer service department of bank 2419. Alternatively, visible proof exchange system 2440 can be operated by an independent entity that is tasked to resolve disputes associated with ATM transactions. When a customer registers a dispute with visible proof exchange system 2440, dispute information 2520 is entered. Dispute information 2520 can include, for example, the date the dispute is registered, the person who input the information, a field to verify whether the dispute was filed by the cardholder, name of the cardholder, one or more telephone numbers of the person who reported the dispute, and an email address of the person. Preferably, additional field 2522 can be provided to enter additional explanation and/or comments associated with the dispute.

List 2530 provides a list of relevant transaction associated with the ATM card. A user of the system can change the number of days the user wants to view transactions and the list can display the transactions accordingly. As shown, list 2530 includes six transactions associated with the ATM card for the last 180 days. List 2530 can be presented in a large number of ways. As shown in FIG. 25, list 2530 provides the following information associated with each transaction: name of financial institution at which a transaction was conducted, the transaction date and time, the ATM location, the transaction sequence number, the transaction type, the transaction type, the amount, and whether the transaction has already been disputed.

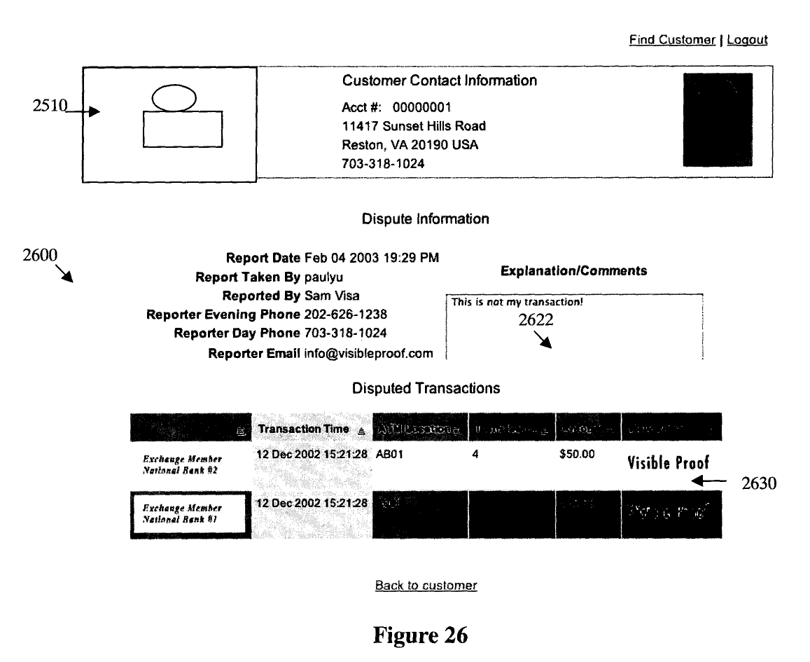

FIG. 26 is another exemplary report that can be generated by visible proof exchange system 2440 of the invention. Report 2600 includes field 2622, which can be used to display comment by a person who reported the dispute. Exemplary report 2600 shows two disputed transactions. For example, during a review of a monthly bank statement, the cardholder noted two suspect transactions that he did not recognize. As shown in FIG. 26, the first disputed transaction took place at ATM location “AB01” and the second disputed transaction took place at ATM location “A001.” Other information associated with the disputed transaction includes name of the bank that owns and operates the ATM, the transaction date and time, transaction sequence number, amount, and a transaction image. When button or icon 2630 is clicked by a user, the transaction image associated with the transaction is displayed.

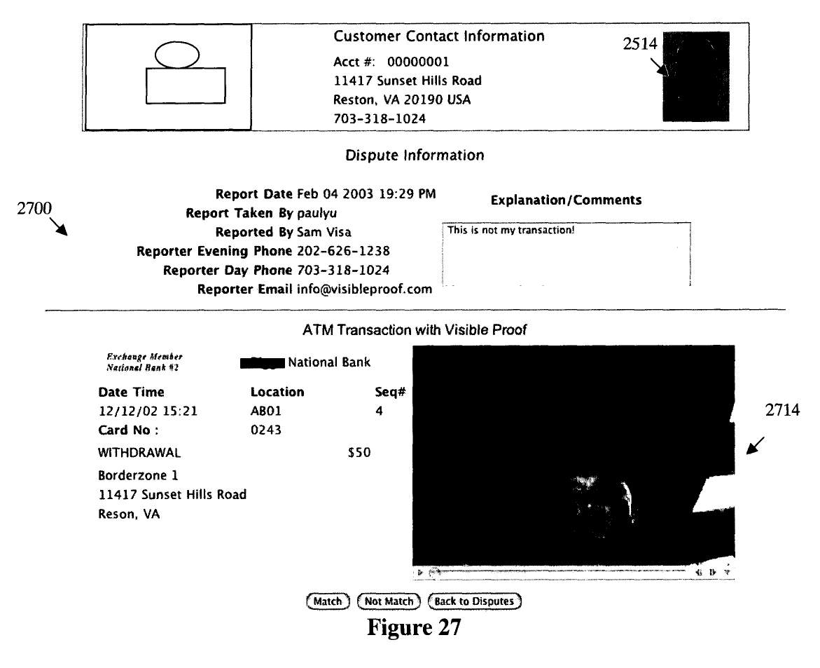

FIG. 27 is an exemplary page showing transaction image 2714 associated with the transaction in question. A comparison of transaction image 2714 with authenticated image 2514 of report 2700 indicates that the transaction party captured in transaction image 2714 is not an authorized person shown in authenticated image 2514.

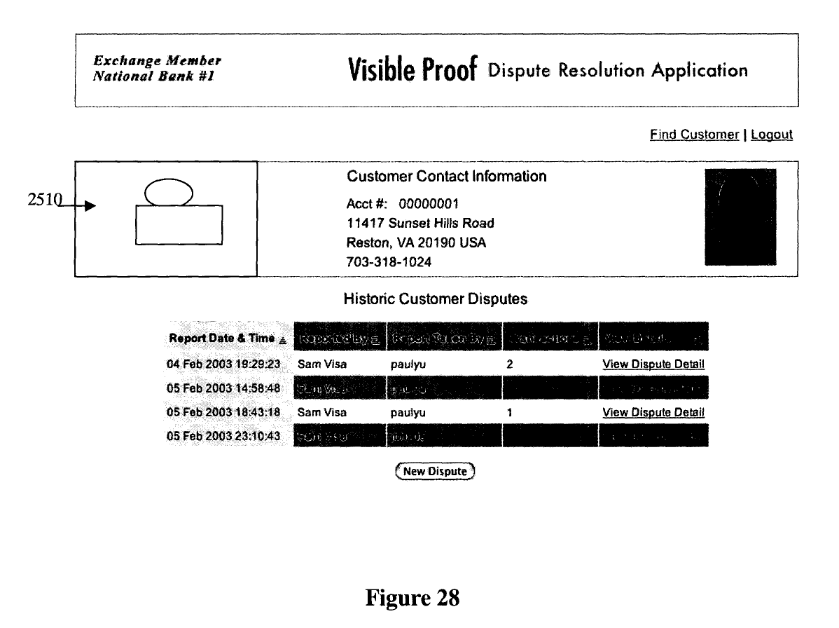

FIG. 28 is an exemplary report that can be generated by visible proof exchange system 2440 to display historic customer disputes.

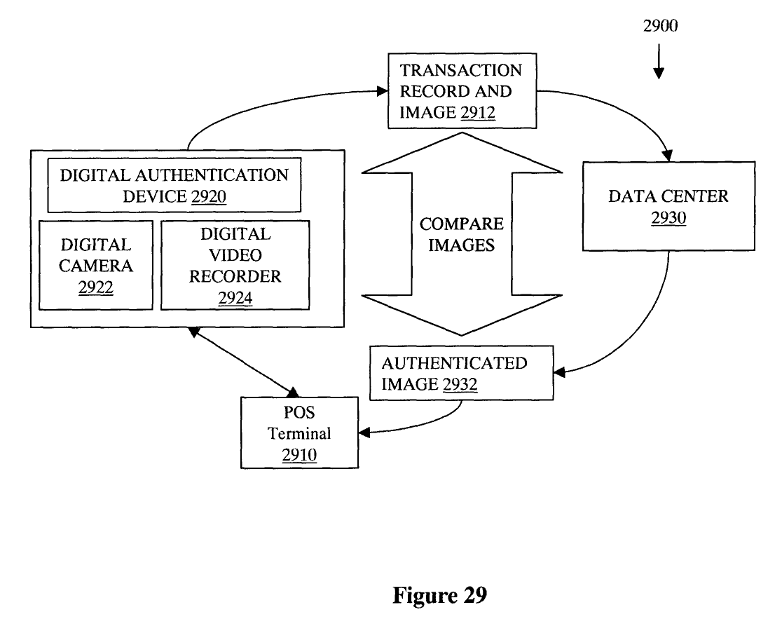

FIG. 29 is a schematic diagram showing an exemplary system that resolves disputes associated with a retail POS (point of sale) transaction. System 2900 includes data center 2930. Data center 2930 can be associated with a financial institution such as a credit card issuer. Alternatively, data center 2930 can be a dispute resolution party that is employed by a credit card holder or the financial institution. Police can also use data center 2930 to solve crimes involving, e.g., fraudulent credit card transactions.

Retail POS terminal 2910 is equipped with digital authentication device 2920. Digital authentication device 2920 preferably includes video camera 2922 that is coupled with a digital video recorder 2924. Digital video recorder 2924 records a transaction party authenticating herself at POS terminal 2910, using either a digital signature pad or a PIN entry device. The primary transaction information and the video are recorded and are used to create transaction record and image 2912.

Transaction record and image 2912 can be kept at POS terminal 2910. Alternatively, transaction record and image 2912 can be sent to visible proof data center 2930 for storage and retrieval.

Visible proof data center 2930 can be staffed by the financial institution that issued the credit card. Alternatively, visible proof data center 2930 can be part of a visible proof dispute resolution network of the invention.

A transaction party uses a signature-based credit card of a customer of a credit card issuer (e.g., a bank) to make a purchase at a retail store. The transaction party may or may not be an authorized person (e.g., authorized person 20 shown in FIG. 1) associated with the credit card. A cashier at the retail store swipes the credit card in a magnetic-stripe reader of POS terminal 2910. In addition, at the time of the transaction, transaction record and image 2912 of the transaction is created. Transaction record and image 2912 includes transaction information and a transaction image of the transaction party as described above. The transaction information and the transaction image can be treated as two different entities as described above, or as a single entity as described below. The transaction information can include, for example, date and time of the transaction, name of the retail store, serial number of POS terminal 2910, etc. Transaction record and image 2912 can be locally stored and later transmitted to or retrieved by data center 2930.

When the card is swiped, the dispute resolution system of the present invention retrieves authenticated image 2932 associated with the credit card, and sends authenticated image 2932 to POS terminal 2910 for display to the cashier. The cashier waits for the authorization from the credit card issuer and authenticated image 2932 associated with the credit card from data center 2930 of the visible proof dispute resolution system of the invention.

Authenticated image 2932 associated with the credit card is that of the authorized person (or the credit card holder). The cashier can then compare authenticated image 2932 with the transaction party as shown on transaction record and image 2912. If the comparison shows that the transaction party is the authorized person, then the transaction would be considered to be legitimate, and the transaction would be successfully concluded. Preferably, transaction image 2912 is then transmitted to data center 2930 for storage and record keeping purposes. If the comparison shows that the transaction party is not the authorized person, then the attempted transaction would be considered to be a fraudulent transaction. The cashier can then notify store security personnel or the police, who can take appropriate actions.

In a different embodiment, if transaction record and image 2912 is transmitted to data center 2930 directly, a person at data center 2930 can compare the transaction image of transaction record and image 2912 with authenticated image 2932. If the comparison indicates that the transaction party is the authorized person, data center 2930 would not provide the required approval for the cashier to conclude the transaction.

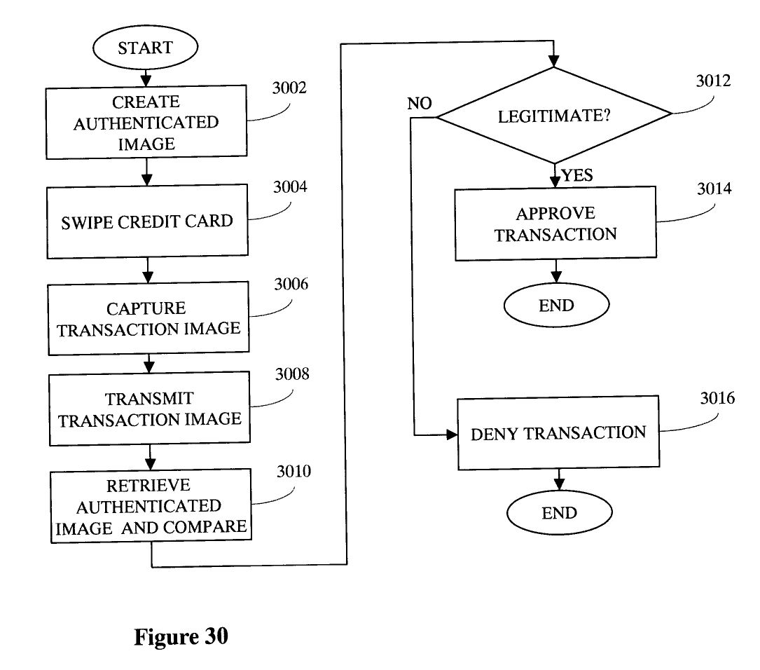

FIG. 30 is a flowchart showing an exemplary process that may be used to implement a preferred embodiment of the present invention. The embodiment assumes that conventional credit card financial authorization has been obtained. Preferably, the financial authorization can be performed by data center 2930 as well.

In step 3002, an authenticated image associated with a credit card is created. The authenticated image can be created when the credit card is approved by a credit card issuer. Preferably, the authenticated image shows the face of the credit card holder, which is an authorized person to use the credit card. More than one authenticated images can be associated with the credit card if there are more than one authorized persons. The authenticated image is stored in data center 2930. In this embodiment, data center 2930 is associated with the credit card issuer. Preferably, data center 2930 is coupled to a system that approves credit card transactions of the credit card issuer.

In step 3004, when a transaction party (who may or may not be the card holder or an authorized person associated with the credit card) presents the credit card at a retail outlet, the credit card is swiped at a credit card reader (e.g., one that is coupled to POS terminal 2910). This is a conventional step that is typically performed by a cashier when the credit card is presented to her by a transaction party. In some retails outlets, e.g., gasoline refilling stations, this step can be performed by the transaction party herself.

In step 3006, a transaction image is captured. The transaction image can be captured by, e.g., digital camera 2922 or digital video recorder 2924.

In step 3008, the transaction image is transmitted to data center 2930. In addition, certain transaction information such as credit card number and the merchant number associated with POS terminal 2910 are also transmitted to data center 2930.

In step 3010, the authenticated image is retrieved and compared with the transaction image. The authenticated image can be retrieved based on, for example, the credit card number.

In step 3012, if it is determined that the transaction image indicates the transaction party to be an authorized person shown in the authenticated image, then the process goes to step 3014. Otherwise, the process goes to step 3016.

In step 3014, the transaction is approved, assuming, of course, the conventional credit card financial authorization has been obtained.

In step 3016, the transaction is denied even if the conventional credit card financial authorization has been obtained.

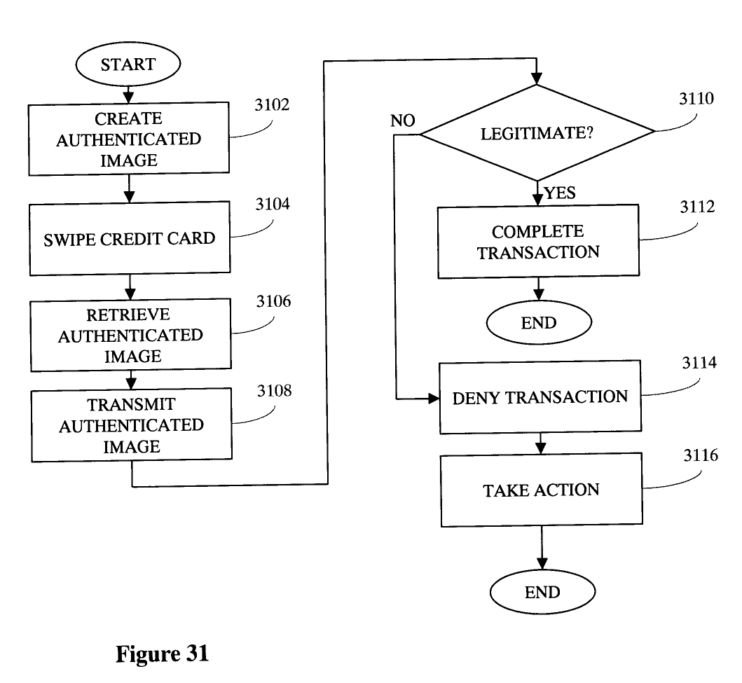

FIG. 31 is a flowchart showing another exemplary process that may be involved in using another preferred embodiment of the present invention.

In step 3102, an authenticated image associated with a credit card is created. This step can be similar to step 3002 described above. The authenticated image is stored in data center 2930.

In step 3104, when a transaction party (who may or may not be the card holder or an authorized person associated with the credit card) presents the credit card at a retail outlet, the credit card is swiped at a credit card reader (e.g., one that is coupled to POS terminal 2910). This is a conventional step that is typically performed by a cashier when the credit card is presented to her by a transaction party. This action allows transmission of certain credit card information, e.g., credit card number, from POS terminal 2910 to data center 2930.

In step 3106, using the credit card number received, data center 2930 retrieved the authenticated image associated with the credit card.

In step 3108, the authenticated image is transmitted by data center 2930 to the POS terminal 2910.

In step 3110, the cashier at POS terminal 2910 views the authenticated image. The cashier can then use the authenticated image to determine the validity of the transaction party's claim that she is the legitimate holder of the credit card at time of purchase. If it is determined that the transaction party who presented the credit card is a legitimate user, i.e., matches the authorized person shown in the authenticated image, then the process goes to step 3112. Otherwise, the process goes to step 3114.

In step 3112, the transaction is completed. This assumes, of course, the conventional credit card financial authorization has been obtained by the cashier.

In step 3114, the transaction is denied even if the conventional credit card financial authorization has been obtained by the cashier.

In optional step 3116, the cashier can take an additional action. The action can be, for example, reporting to police that the transaction party attempted to use a stolen credit card.

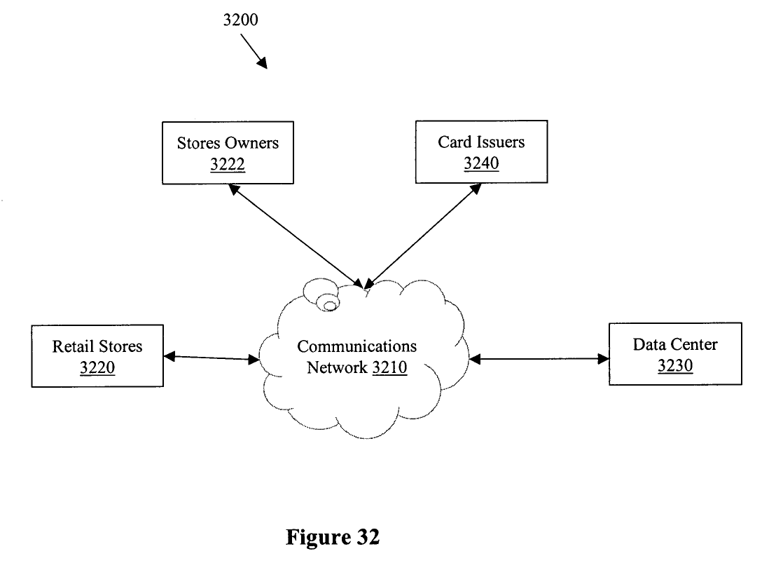

FIG. 32 illustrates an exemplary system architecture of a preferred embodiment of the invention related to retail stores. Network 3200 of the invention is hereinafter known as the Retail Fraud and Loss Prevention Network. In the preferred embodiment depicted in FIG. 32, network 3200 includes retail stores 3220, store owners 3222, card issuers 3240, and data center 3230. Through communications network 3210, retail stores 3220, store owners 3222, card issuers 3240, and data center 3230 can communicate among themselves. Communications network 3210 can be, for example, the Internet. Communication network 3210 can also other known network, including for example, a virtual private network. Retails stores 3220 are owned by stores owners 3222. Card issuers 3240 can be, for example, financial institutions such as banks that issue credit cards that can be used to make transactions at retails stores 3220.

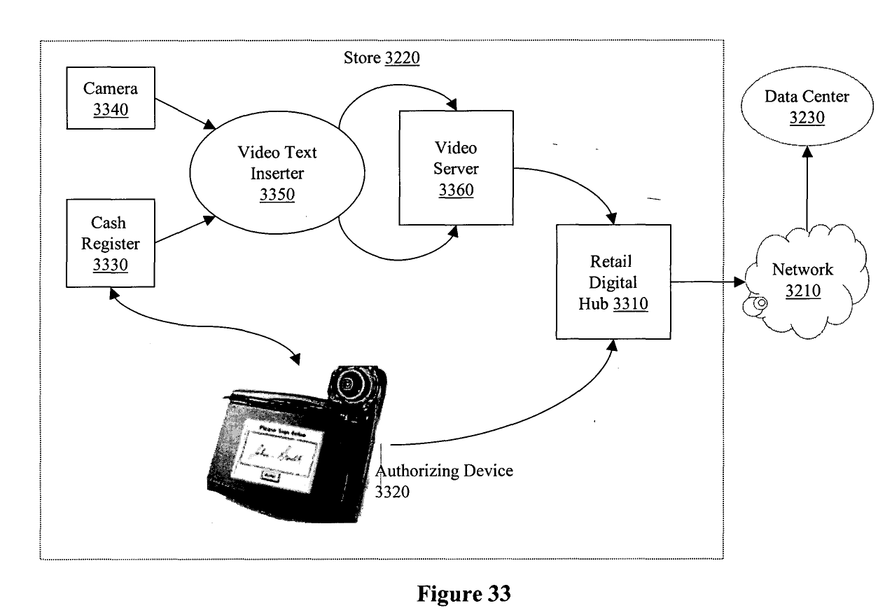

FIG. 33 illustrates an exemplary hardware architecture that can be implemented in retail store 3220, which is part of network 3200. Retail store 3220 includes camera 3340, cash register 3330, video text inserter 3350, video server 3360, digital authorizing device 3320, and retail digital hub 3310. Retail digital hub 3310 is connected to communications network 3210.

Cash register 3330 can be a known point-of-sales cash register with scanner or reader. Cash register 3330 can be, for example, one that can be obtained from IBM, NCR, or Micros. Camera 3340 can be an analog camera that is obtainable from Pelco, Ultrex, Panasonic, etc. Video text inserter 3350 can be obtained from American Video Enterprise or Transaction Verification Systems. Video server 3360 with Quad-BNC can be one which is available from ComCam International.

A serial connector can be used to connect digital authorizing device 3320 to cash register 3330. An IP-based transmission over Ethernet (wired or wireless) can be provided to connect retail digital hub 3310 to digital authorizing device 3320 and video server 3360. Between camera 3340 and video text inserter 3350, video transmission can be done over thin-coax cables. Between cash register 3330 and video text inserter 3350, text transmission can be performed over RS-232 standard or the like. From retail digital hub 3310 to communications network 3210, high speed connection is preferable, for example, connections such T1, T3, DSL, or Cable Modem are desirable. It is noted that camera 3340 is used to protect the interests of store owners 3222, and digital authorizing device 3320 is used to protect the interests of card issuers 3240.

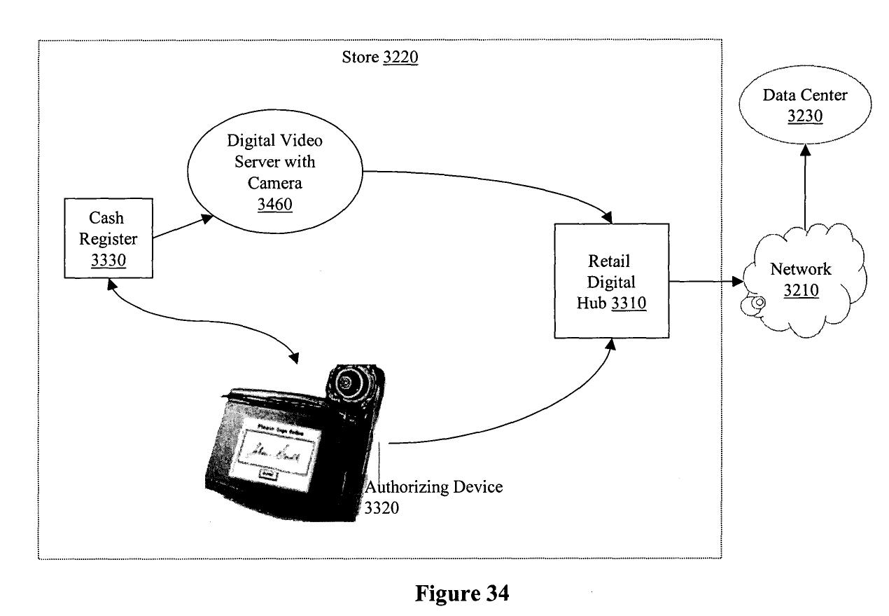

FIG. 34 illustrates another exemplary hardware architecture that can be implemented in store 3220 of network 3200 as shown in FIG. 32. In this embodiment, digital network camera 3460 replaces analog camera 3340, text inserter 3350, and video server 3360 shown in FIG. 33.

Preferably, digital network camera 3460 includes a digital video server. The digital video server can be obtained from ComCam International with embedded logic to perform text insertion function.

The connection between digital network camera 3460 and retail digital hub 3310 is preferably IP based transmission over Ethernet. It can be wired or wireless. The connection between cash register 3330 and digital network camera 3460 includes text transmission over RS-232 or the like.

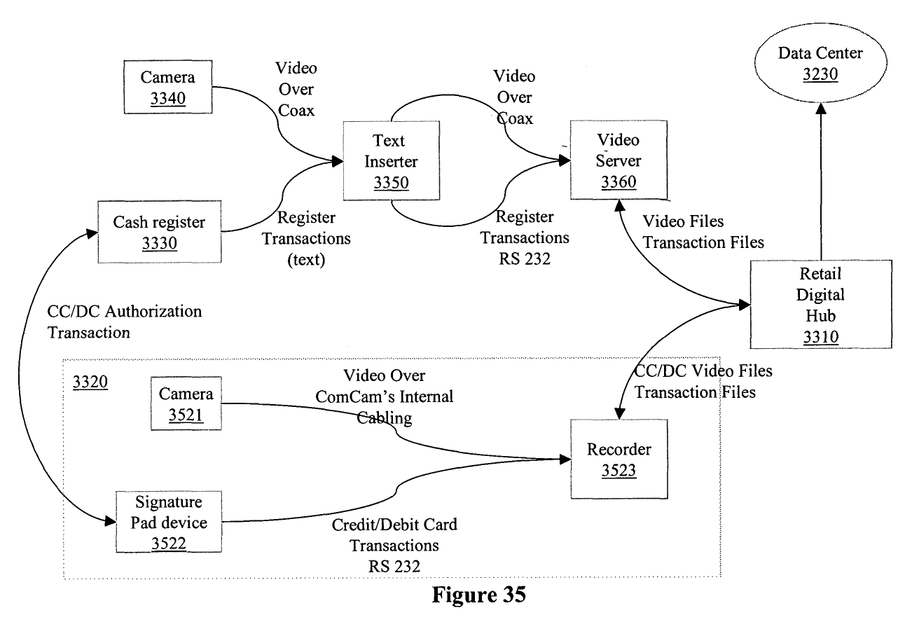

FIG. 35 shows an exemplary flow of video and textual data between the various devices shown in FIG. 33. As shown in FIG. 35, digital authorizing device 3320 includes camera 3521, signature pad device 3522, and recorder 3523.

Analog video signal associated with a transaction image showing the cashier, cash register 3330, and the customer is sent by camera 3340 to text inserter 3350 over coax cable. Digital data is sent by cash register 3330 to text inserter 3350 over RS-232. Text inserter 3350 converts digital data from cash register 3330, formats the data, and superimposes the transaction over the video received from camera 3340. From text inserter 3350 to video server 3360, video with superimposed transaction information is transmitted over coax cable to the BNC connector of video server 3360. In addition, serial signal of the transaction information is sent to the RJ-11 connector of video server 3360.

Video files, encoded with either Wavelet, H263, MJPEG, JPEG, or similar means, and textual transaction information is sent from video server 3360 to retail digital hub 3310 via IP over either wired or wireless Ethernet.

As described above in FIG. 33, device 3320 is preferably a digital signature pad with camera. From device 3320, credit and debit card approval requests and signature image transactions is sent to and receive from cash register 3330 within the normal processing of product purchase transaction.

In an exemplary implementation, device 3320 can include camera 3521, signature pad device 3522, and recorder 3523. From signature pad device 3522 to recorder 3523, credit and debit card information, e.g., Card Number, Owner Name, Expiration Date, Transaction Amount, Approval Code, Transaction Date/Time, is transmitted over RS232 or similar means to recorder 3523. Digital video signal is sent to from camera 3521 to recorder 3523. Recorder 3523 superimposes transactional information over the video signal, captures the transaction information in a file, and transmit both sets of data to retail digital hub 3310.

From signature pad device 3523, video files, encoded with either Wavelet, H263, MJPEG, JPEG, or similar means, and textual transaction information is sent via IP over either wired or wireless Ethernet to retail digital hub 3310. Retail digital hub 3310 then transmits the POS and credit card/debit card transaction file and video files to data center 3230 over network 3210.

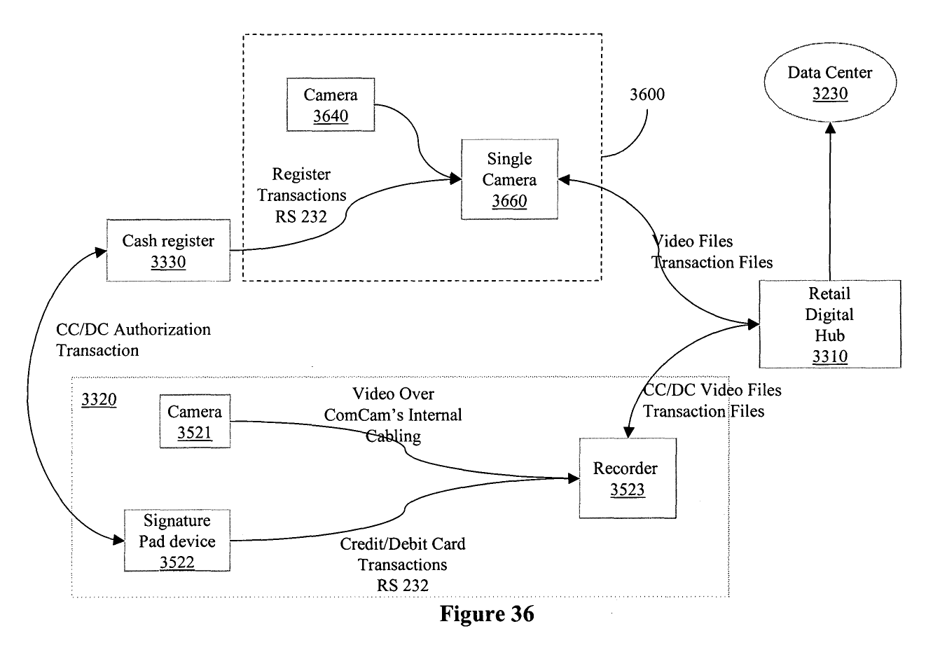

FIG. 36 shows the flow of video and textual data between the various devices shown in FIG. 34, where a digital camera is used instead of an analog camera. FIG. 36 is substantially similar to FIG. 35, except elements enclosed in box 3600. Single camera 3660 can be ComCam Single Camera. Single camera 3660 combines functionalities of camera 3340, video text inserter 3350, and video server 3360 into a single device.

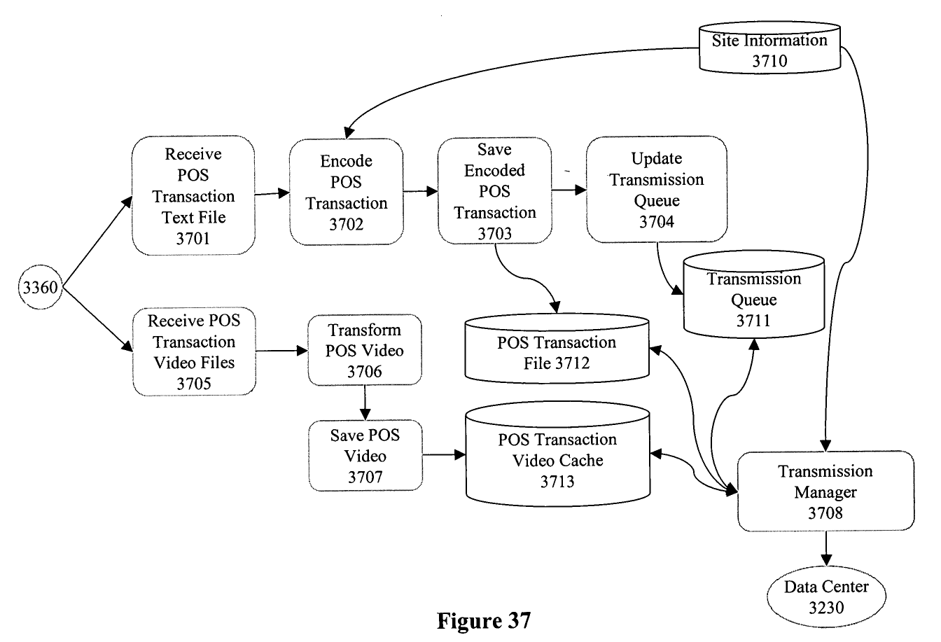

FIG. 37 illustrates the data flow within retail digital hub 3310 as it processes the point-of-sales (POS) transactional ASCII data and the video data for transmission to the network data center 3210. This process is similar to that described in FIG. 16. Retail digital hub 3310 receives the POS transaction information from either video server 3360 or cash register 3330. Retail digital hub 3310 receives the POS transaction video from video server 3360. The POS transaction is encoded with additional information as necessary, e.g., store identification number, and stores the transactions in either flatfile, XML or a database management system. The stored POS transactions are marked for transmission and placed in transmission queue 3711. On a periodic basis, e.g. nightly, half-daily, or hourly, depending on the requirements of the store management, the POS transactions are transmitted to data center 3230. The POS transaction videos are transformed, if necessary, to another format, and stored on retail digital hub 3310 for either transmission to data center 3230 or for later retrieval. In another embodiment, the video could be left on video server 3360 and retrieved upon request from retail digital hub 3310.

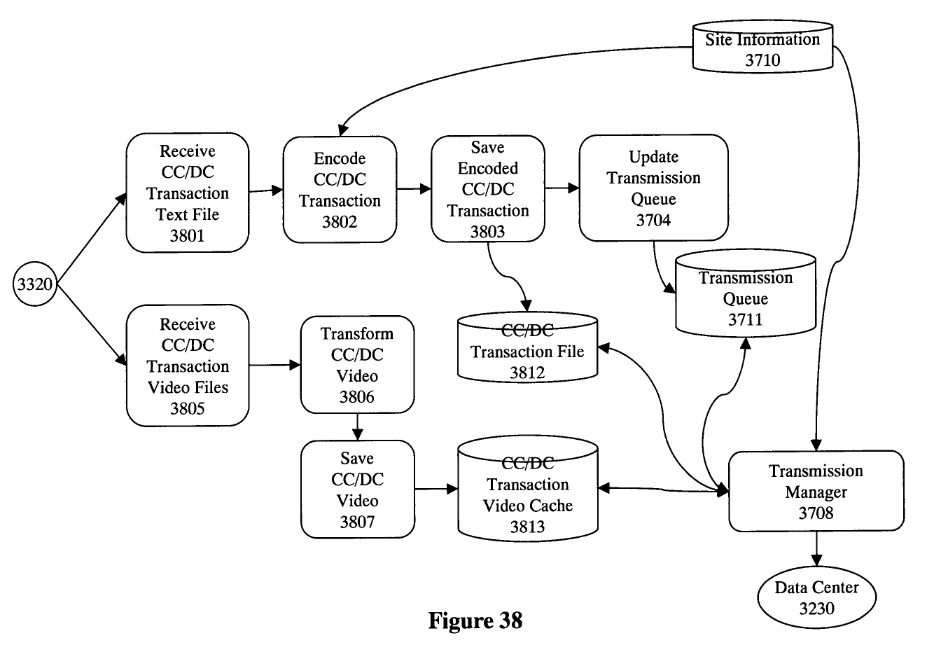

FIG. 38 illustrates the data flow within retail digital hub 3310 as it processes the credit or debit card (CC/DC) transactional data and the video data for transmission to the network data center 3230. This process is similar to that described in FIG. 37 except credit or debit card transaction information from device 3320 is used instead of POS information from video server 3360. Retail digital hub 3310 receives the credit or debit card transaction data from either authorizing device 3320 or cash register 3330. The transaction data is encoded in step 3802 with additional information if necessary, e.g., the addition of store information, and stored in step 3803 in the file system or a database system on retail digital hub 3310. Transmission queue is updated in step 3704 to indicate that the processed credit or debit card transaction is ready to transmit. Retail digital hub 3310 receives the video associated with the credit or debit card transaction in step 3805 and transforms the video to another format in step 3806 if necessary. The properly formatted video is stored in step 3807 on the file system or a database management system 3813. The credit or debit card transaction video may be transmitted to data center 3230 or cached at retail digital hub 3310 for later retrieval.

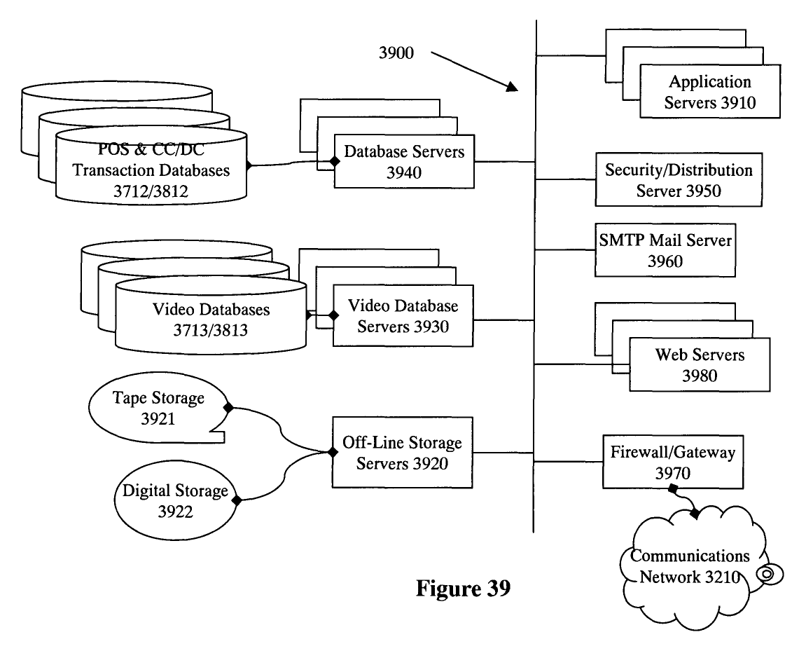

FIG. 39 illustrates the multi-tier relationship between the various systems in data center 3230 to deal with the massive amounts of both transactional and video data. This process is similar to that described in FIG. 17.

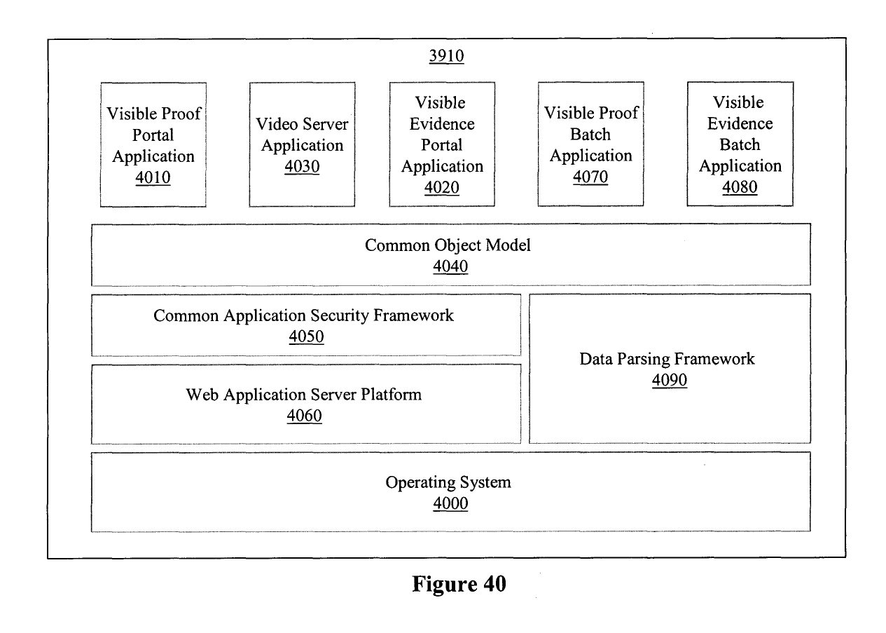

FIG. 40 illustrates the architecture of the Visible Proof and Visible Evidence Applications. This is similar to that described in FIG. 18 with the addition of visible evidence portal application 4020 and visible evident batch application 4080.

Operating System 4000 is the generally available server operating systems, e.g., Apple OS X Server, IBM AUX, Sun Solaris, Redhat Linux or the like.

Visible proof portal application 4010 can be written in either the Java or Java like programming languages of the available web application platforms, e.g., Apple's WebObjects, BEA's WebLogic, IBM's WebSphere, or the like. This application manages the interaction between the store owners and the point-of-sales information. Once the store owners have identified the video information that they would like to review, this application interacts with video server application 4030 to stream the video to the store owner, decode with either Wavelet, H.263 or other video compression format, as necessary.

Visible evidence portal application 4020 can be written in either the Java or Java like programming languages of the available web application platforms, e.g., Apple's WebObjects, BEA's WebLogic, IBM's WebSphere, or the like. This application manages the interaction between the financial institutions, e.g., banks, credit card issuers, debit card issuers, and authorizing device 3320 transaction information. Once the financial institution users have identified the video information that they would like to review, this application interacts with video server application 4030 to stream the video to the financial institution.

Video server application 4030 is responsible for sending the requested video stream to visible proof batch application 4070 and visible evidence batch application 4080. Video server application 4030 is also responsible for decoding of the video files for the transmission, and managing the video streams to the appropriate visible proof and visible evidence session.

Common object model 4040 interfaces with 4010 visible evidence portal application, 4020 visible evidence portal application and video server application 4030. Common object model 4040 manages the translation of relational data into the run-time object model. Data parsing framework 4090 are similar to corresponding common application security framework 1850, web application server platform 1860, and data parsing framework 1890, respectively described in FIG. 18.

Common application security framework 4050, web application server platform 4060 Visible proof batch applications 4070 may reside on their own batch application servers. Similarly, Visible evidence batch applications 4080 may reside on their own batch application servers.

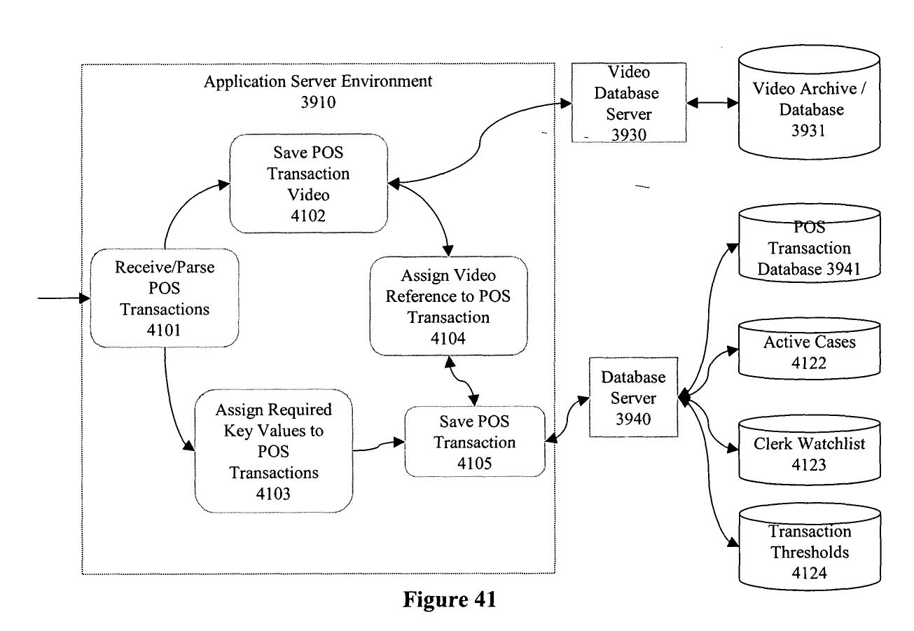

FIG. 41 illustrates the major processes necessary to receive the video and transaction files from the retail stores and processes them for storage at the data center and later retrieval by the customers. This is similar to that described in FIG. 19, except this is for POS transactions rather than for ATM transactions.

New elements shown in FIG. 41 that are not present in FIG. 19 includes: active cases database files (tables) 4122, clerk watchlist database files (tables) 4123, and transaction threshold, and reporting requirements files (tables) 4124. These new elements are the parameters to control the reporting the massive amounts of data stored in the database. Clerk watchlist 4123 is where the clerks that under suspicion can be recorded and used as a parameter to retrieve their POS transactions to review. Transaction threshold table 4124 allows the store owners to set limits for transactions that will be reviewed. Active cases 4122 is the grouping of suspicious transactions that are being actively reviewed. The reporting requirements table(s) would record the many other parameters for reporting, e.g., frequency, report receiver, etc.

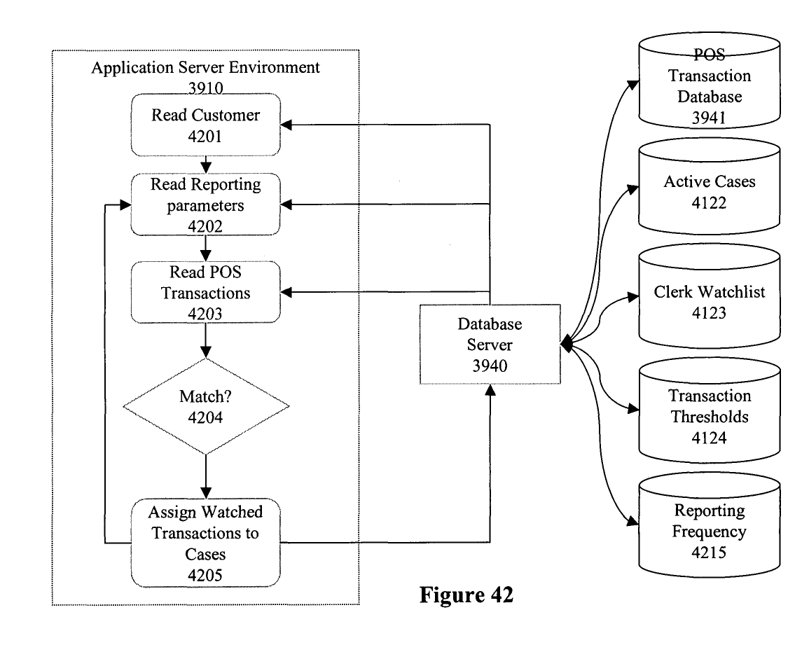

FIG. 42 illustrates the batch process to analyze POS transactions for suspicious activity based on the reporting parameters set by the store owners or their loss prevention specialists, and assign these transactions to active case folders for the store owners to review. Within application server environment 3910, an exemplary process may involve steps 4201 through 4205 described below.

In step 4201, the retail store customers are read into memory.

In step 4202, customer's reporting parameters are read from database server 3940.

In step 4203, the POS transactions are read into memory.

In step 4204, the transaction is compared against the reporting parameters and the clerk watchlist. If there is match, the process goes to step 4205.

In step 4205, the transaction is assigned to active case 4122. If the case does not exist for this transaction, then a new case is created.

POS transaction database 3941 is needed to store the records from the point-of-sales terminals, e.g., transaction, line items, names of clerks.

Active cases database 4122 is a group of database tables that is necessary to store the records that make up the concept of a case folder, e.g., case folder, case officer, case actions.

Clerk Watchlist database 4123 includes database tables that store the clerks that have been flagged as candidates for improper activity.

Transaction thresholds database 4124 include a group of tables that make up the parameters that the store's management has established to identify interesting transactions, e.g., “sweet heart” dealings, stealing cash from the drawers, coupon fraud, etc.

Reporting frequency database 4215 includes a group of tables to store the reporting frequency that the store's management has established for their reports.

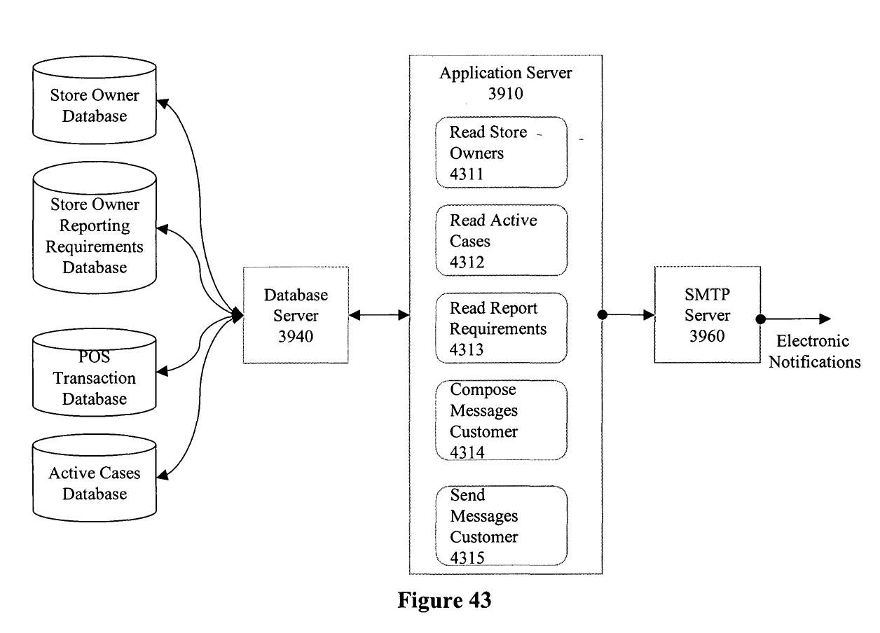

FIG. 43 illustrates an exemplary electronic notification process that can be used to alert the storeowner customer of potentially interesting transactions for their review.

Database server 3940 responds to SQL transaction calls from programs on application server 3910. An exemplary process involved in application server 3910 can include the following steps.

In step 4311, the active store owner customers with electronic notification services are read into memory.

In step 4312, the active cases for the customer are read into memory for processing.

In step 4313, the reporting requirements for the customer are read in sequence or all at once.

In step 4314, based on the reporting requirements and the cases, electronic messages are composed in the appropriate message format.

In step 4315, the composed messages are sent via SMTP server 3960.

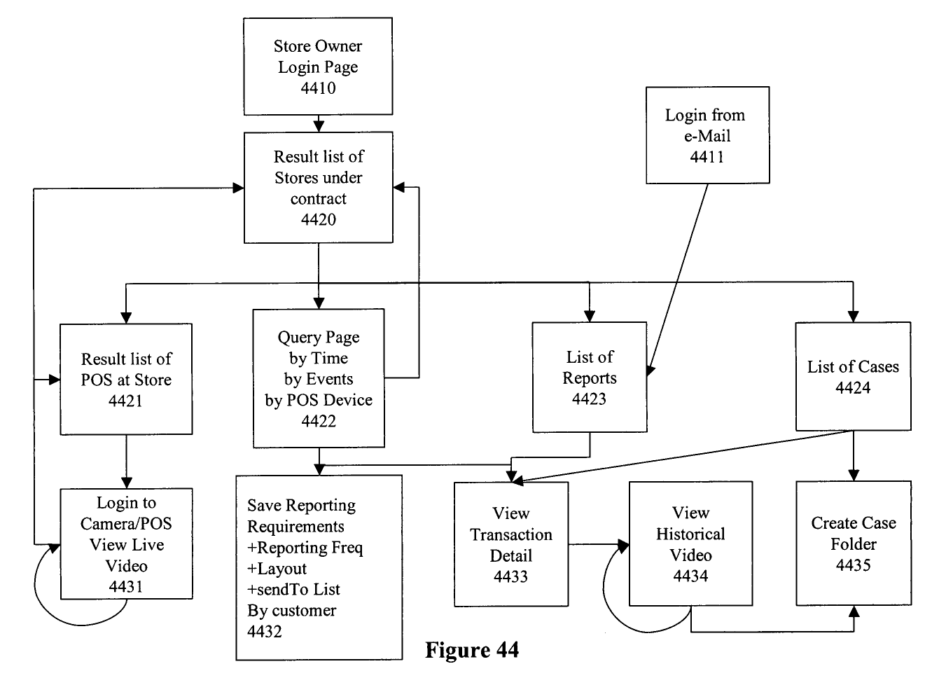

FIG. 44 illustrates an exemplary structure of visible proof portal application 4010 to all retail store owners to access the POS transactions and the associated video from their web-browser.

Page 4410 is the main interactive login page for the storeowners. The user can be authenticated using appropriate security algorithms.

Page 4411 represents an email notification as described above and shown in FIG. 43. The email preferably includes a hyperlink. The user can follow the hyperlink to access the system from that hyperlink contained in the email.

Page 4420 is main menu page of the system, and it includes a search results list of stores under contract.

Page 4421 can be used to display a result list of POS terminals at the stores under contract. Page 4421 can include menu choice of “live connect to selected store.”

Using page 4431, the user can login to camera and/or POS terminal to view live images.

Page 4422 can be used as a query definition page to make a number of different queries. For example, the customer can define their ad hoc reporting parameters.

Page 4432 is where the customer can define the reporting frequency, the reporting layout, the send to list, and save the reporting parameters for later processing.

Page 4423 includes a list of reports. The active reports headers can be displayed on page 44 for the customer. The customer can follow the hyperlink to view the details of the transaction on page 4433.

Page 4433 is the view transaction detail page, at which the detail POS transactions for this report can be reviewed and the customer can follow the hyperlink to view the video associated with the transaction in page 4434. Here, the customer can assign this video to a new case or an existing case.

On page 4434, the user can view a historical video page.

On page 4424, a list of active cases can be displayed.

Using 4435, the customer can assign transactions to follow-up on and to create visible proof of any illegitimate activity.

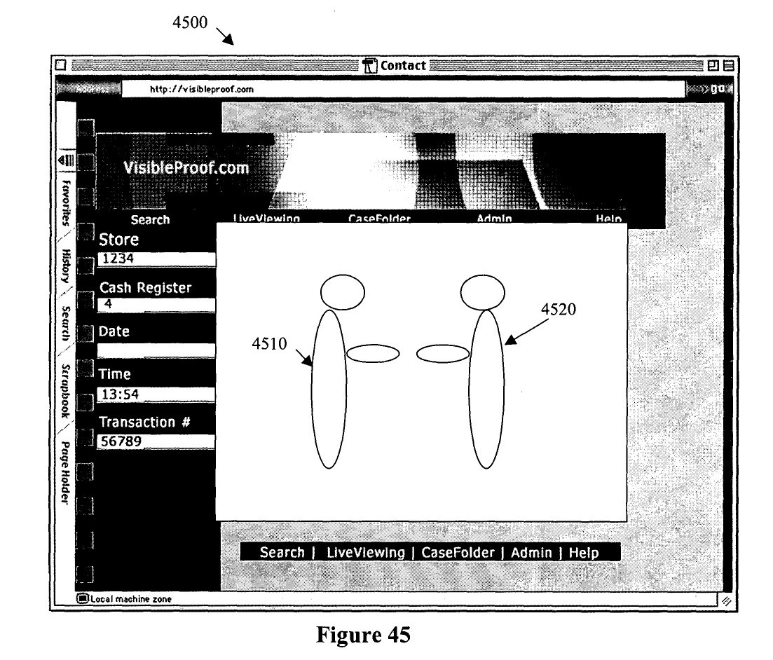

FIG. 45 illustrates an exemplary screen depicting the integration of textual POS transaction information. In this exemplary implementation of the invention, screen 4500 includes a video images of clerk 4510 and customer 4520 checking out at a POS terminal, e.g., cash register 3330.

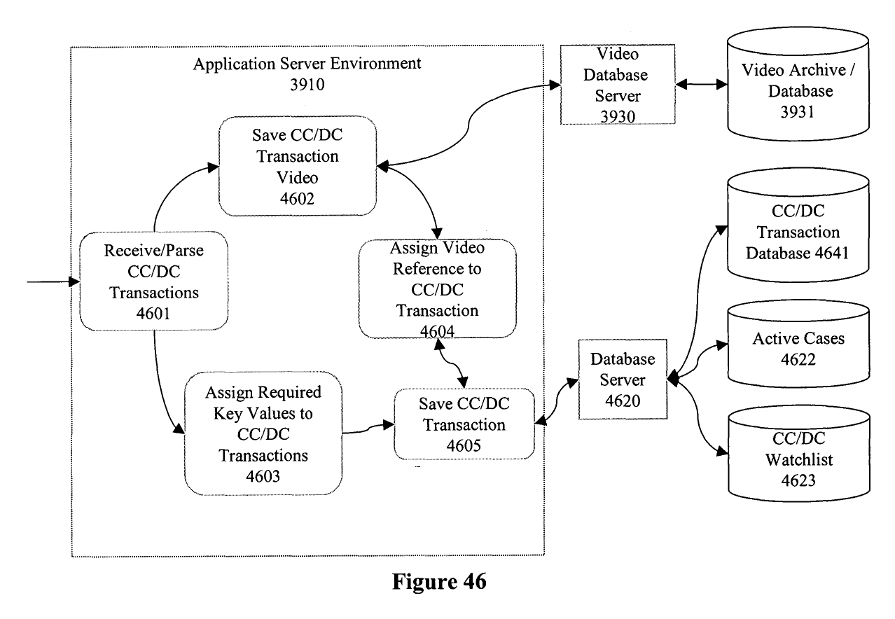

FIG. 46 illustrates the major processes on the application servers to process the incoming video and encoded transactions from the retail stores. The processes of FIG. 46 are similar to those described in FIG. 41. Instead of process POS transactions as described in FIG. 41, FIG. 46 processes credit card and debit card (CC/DC) information.

Processes 4601, 4602, 4603, 4604, and 4605 are similar to corresponding processes 4101, 4102, 4103, 4104, and 4105. Databases 4641, 4622, and 4623 are similar to corresponding databases 3941, 4122, and 4123 shown in FIG. 41.

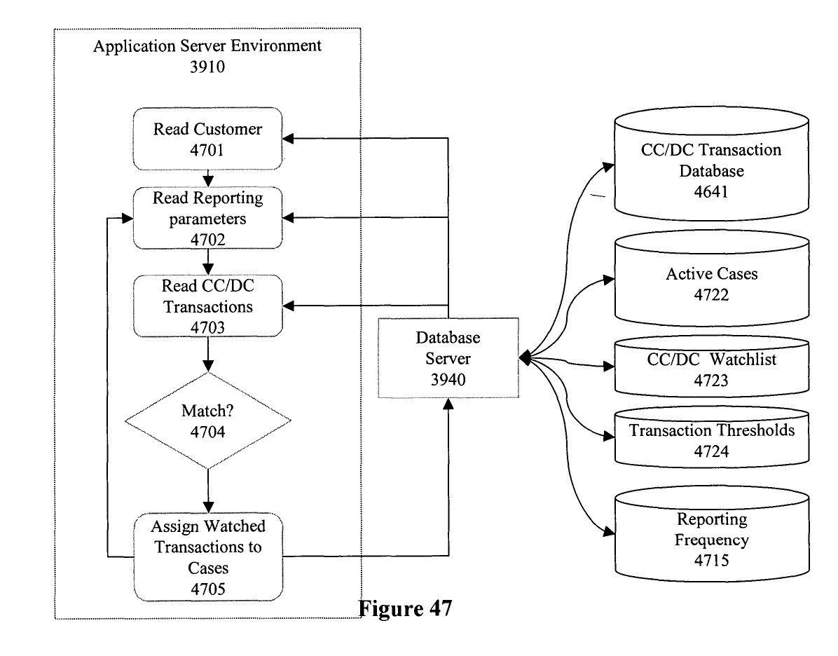

FIG. 47 illustrates the batch process to analyze credit card or debit card transactions for suspicious activity based on the reporting parameters set by the financial institutions, and assign these transactions to active case folders for the financial institutions to review. Processes of FIG. 47 are similar to those described in FIG. 42.

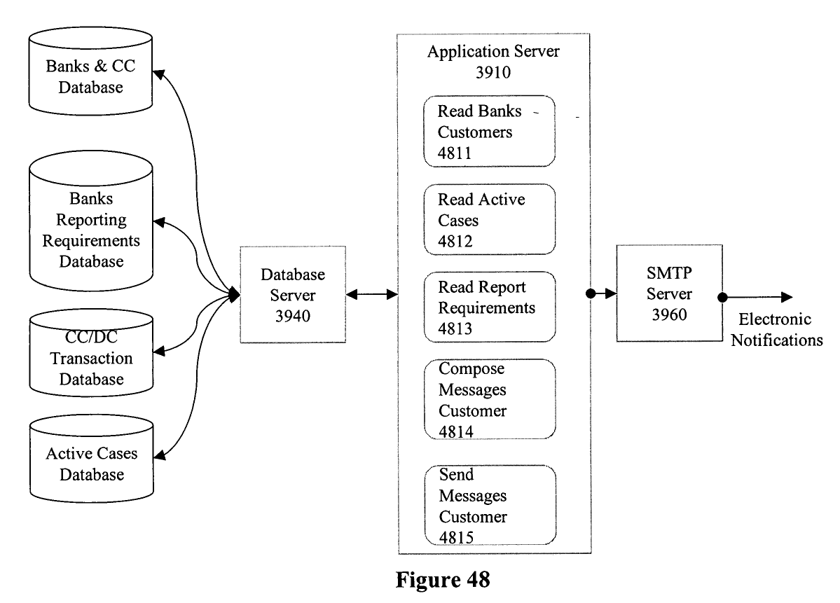

FIG. 48 illustrates the electronic notification processes to alert the financial institution customer of potentially fraudulent credit card purchase transaction for their review. The processes of FIG. 48 is similar to those described in FIG. 43.

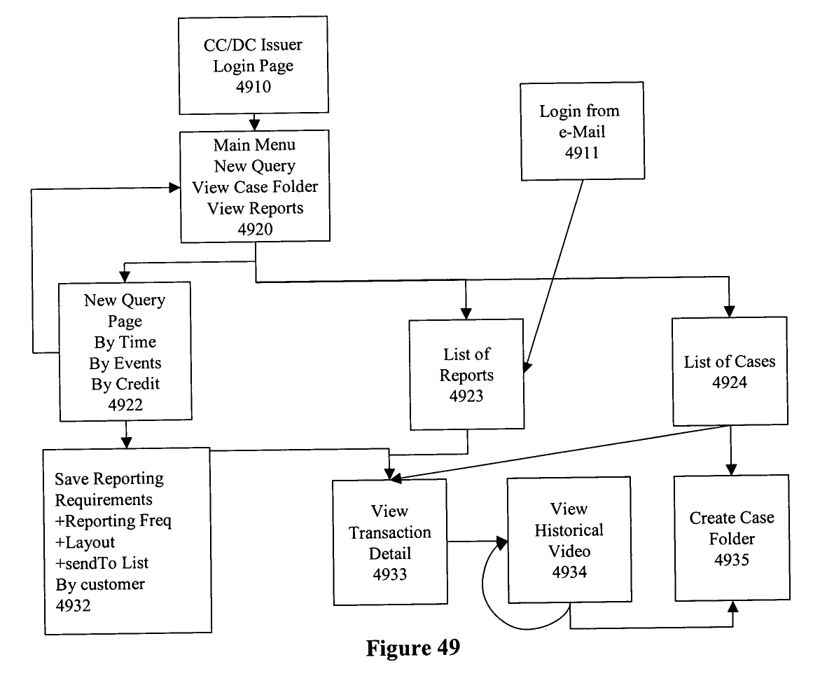

FIG. 49 illustrates the sample structure of visible evidence portal application 4020 to all financial institutions to access the credit and debit card transactions and the associated video from their web-browser. Processes of FIG. 49 are similar to those described in FIG. 44.

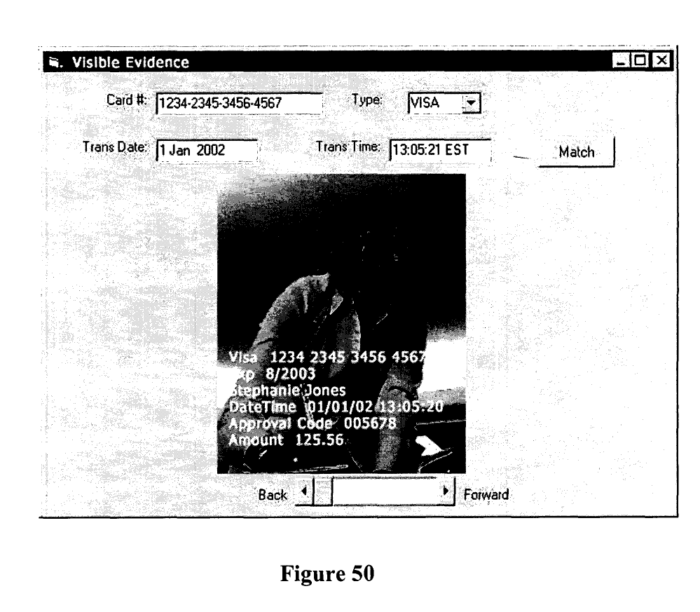

FIG. 50 illustrates a sample screen depicting the integration of textual credit card transaction information with the video images of the cardholder signing on a signature pad with camera device (e.g., authorizing device 3320 shown in FIG. 33).

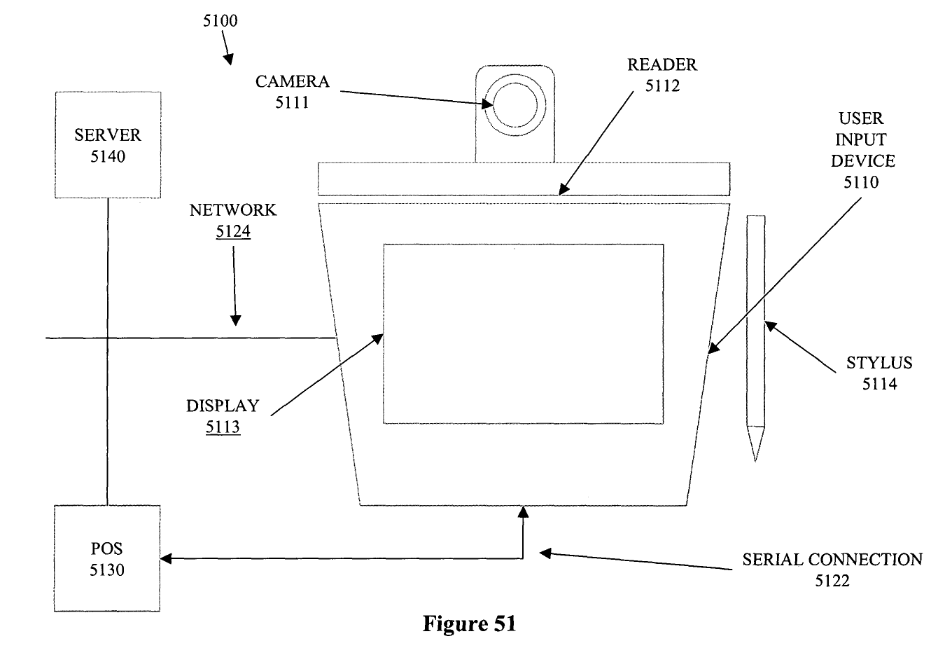

FIG. 51 is a schematic diagram showing a preferred embodiment of a signature pad with camera device of the invention. Device 5100 can be used, for example, as digital authorizing device 3320 shown in FIGS. 33 and 34. Device 5100 includes user input device 5110, camera 5111, reader 5112, display 5113, and stylus 5114.

User input device 5110 can be a signature pad as shown in FIG. 51. In another embodiment, user input device 5110 can be a PIN-input pad that includes several buttons. User input device 5110 is used today to authenticate a consumer who attempts to make the electronic financial transaction.

Camera 5111 is the camera that is use the capture the video of the consumer authenticating the transaction. This camera can be either a network camera or a digital camera with USB, IEEE 1394, or analog transmission medium. This illustration is that of an network camera that would communicate with point of sale terminal 5130 and server 5140 through network 5124.

Reader 5112 is used to read information associated with or encoded within an electronics transaction card such as a credit card, a debit card, and the like. For example, reader 5112 can be a magnetic stripe reader, a smart-card reader, or the like. Reader 5112 captures the account identity to be used in the financial transaction.

Display 5113 is the authentication sub-component of user input device 5110. This sub-component on a signature pad would be the touch-sensitive screen to capture the signature of the consumer making the transaction. This sub-component on a PIN pad would be the numeric key-pad (either mechanical or electronic) where the consumer can authenticate by entering his or her PIN.

Stylus 5114 is the stylus of a digital signature pad. The consumer would use the stylus to digitally sign the credit card authorization receipt. The stylus would not be necessary for a PIN-based transaction.

Serial connection 5122 located between device 5100 POS terminal 5130. This serial connection can be either RS 232, RS422-based or USB/USB2-based serial communication.

Network 5124 is preferably an Ethernet Network. Either wired, e.g., 10/100/1G BaseT or Wireless, e.g., 802.11a, b, g, can be used.

Point-of-sale terminal 5130 is where the consumer is making the financial transaction, either purchasing some goods or withdrawing money from a teller window.

Server 5140 is the video storage server to store the authentication video captured by camera 5111.

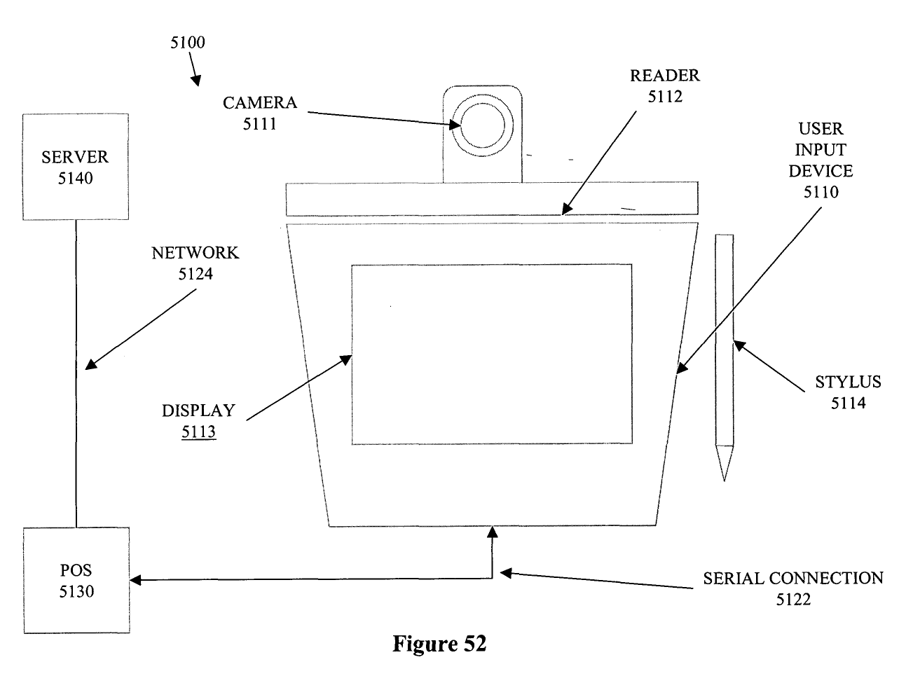

FIG. 52 illustrates the invention using a camera connected POS terminal 5130 through serial connection 5122. In this configuration, camera 5111 of device 5100 can be a simple video capture device. Digitization of the video and recording are done in POS terminal 5130. POS terminal 5130 uses serial connection 5122, preferably a USB or USB2 link, to communicate with both user input device 5110 and camera 5111.

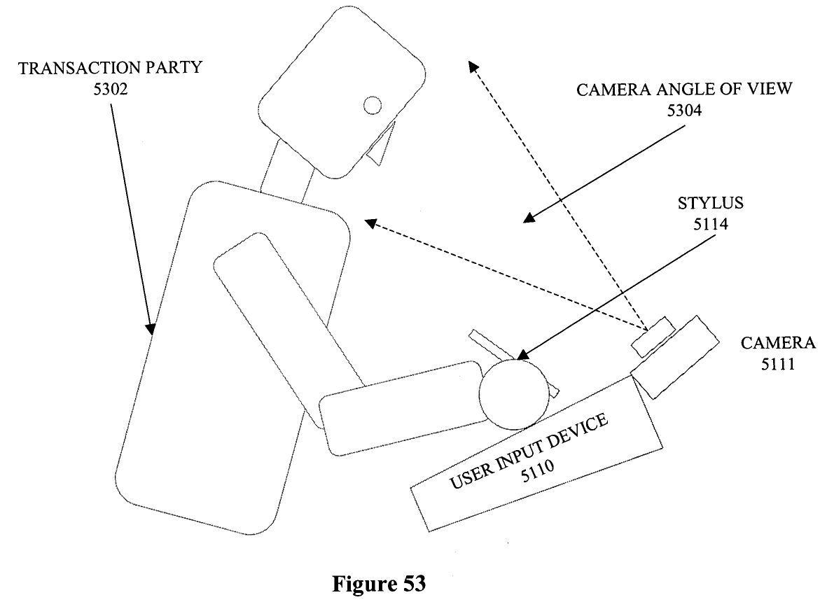

FIG. 53 illustrates a preferred position of camera 5111 to capture a transaction image of transaction party 5302. Camera 5111 is preferably position to provide camera viewing angle 5304. The best viewing angle is where camera 5111 can capture the entire face of transaction party 5302 who is conducting the transaction. The ideal position of camera 5111 is out of the way of the hand of transaction party 5302 while transaction party 5302 is signing or entering a PIN onto user input device 5110.

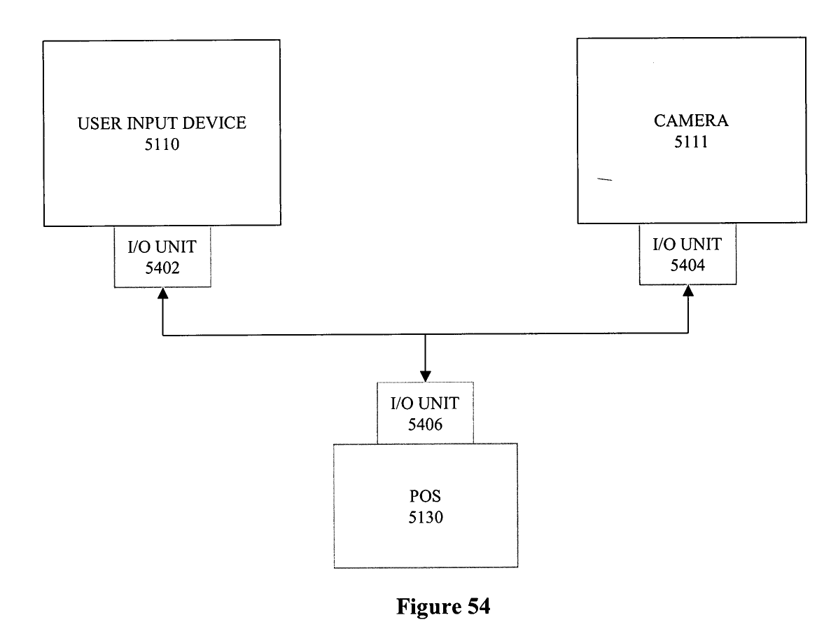

FIG. 54 is a schematic showing relative positions of user input device 5110, camera 5111, and POS terminal 5130. The interaction between these devices are through their respective input/output (I/O) units 5402, 5404, and 5406. I/O units 5402, 5404, and 5406 can be either serial communication ports, IEEE 1394, or Network Ports.

POS terminal 5130 sends a request to user input device 5110 to authenticate a financial transaction. User input device 5110 processes the signature or PIN entry input by transaction party 5302. User input device 5110 notifies both POS terminal 5130 and camera 5111 that it is processing the signature or PIN entry. User input device 5110 also notifies both POS terminal 5130 and camera 5111 when the process is complete.

If POS terminal 5130 is controlling the recording, then when POS terminal 5130 receives the start processing signature or PIN message, POS terminal 5130 signals camera 5111 or itself to start recording. When the signature or PIN processing is complete, then POS terminal 5130 signals camera 5111 to stop recording.

If camera 5111 has built-in intelligence and can respond to the signals directly from user input device 5110, then camera 5111 could record transaction party 5302 when it receives the start processing signal from user input device 5110 and stop recording when it receives the end-processing signal.

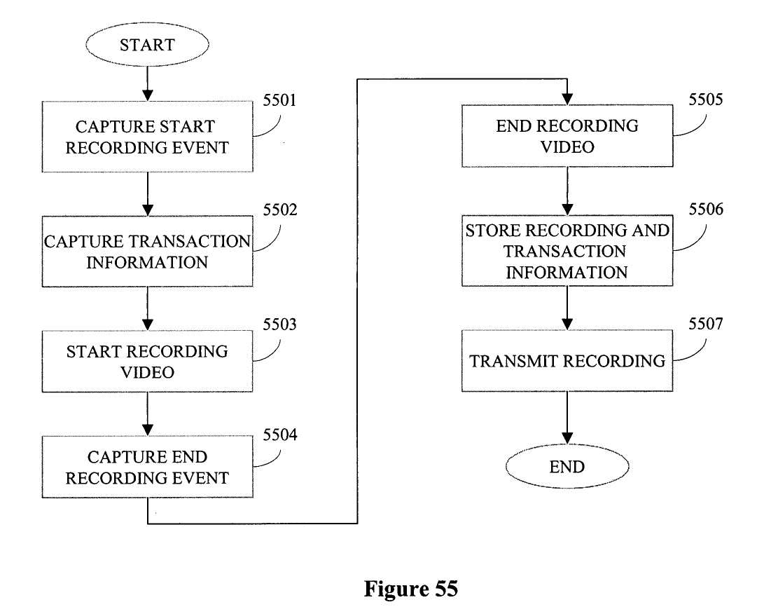

FIG. 55 is a flowchart showing an exemplary process associated with the controlling of camera 5111. This logic could reside in either POS terminal 5130, user input device 5110, camera 5111, or somewhere within digital authorizing device 5100.

In step 5501, the start of recording events could be triggered by, e.g., pen-down, PIN entry, or card swipe.

In step 5502, the credit or debit card transaction information, e.g., card number, card holder name, transaction amount, transaction date, approval code is captured.

In step 5503, the transaction information is overlaid or embedded into the video data stream.

In step 5504, upon receiving the start recording event, the video images seen by camera 5111 are captured, encoded, and recorded. The recording continues until a stop recording event message is received.

In step 5605, upon receiving the stop recording message, recording stops. Alternatively, device 5100 (or another component of the system) can be configured to continue recording for a predetermined duration.

In step 5606, the captured video and transaction information is stored to permanent media, e.g., hard disk, flash memory, and the like.

In step 5607, the recording is transmitted.

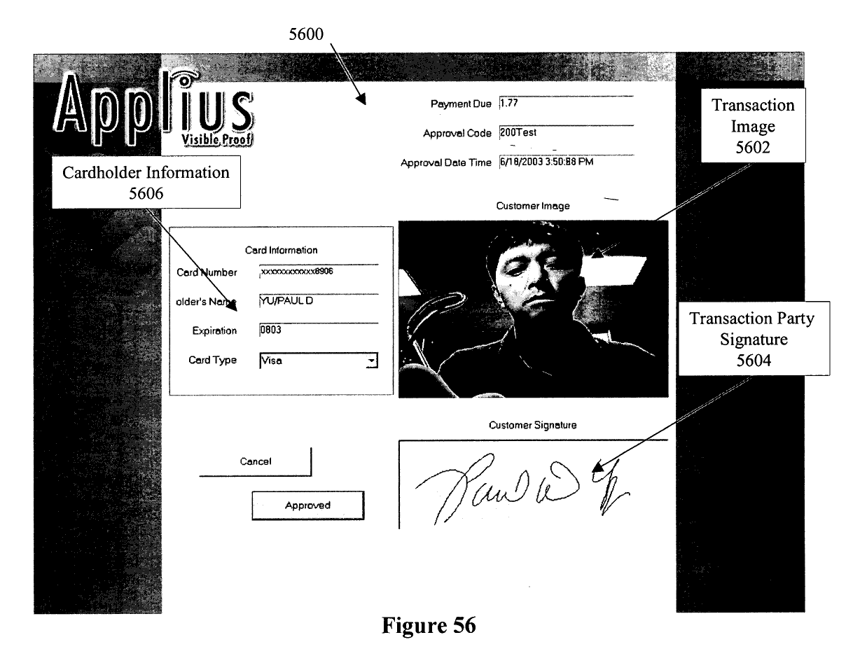

FIG. 56 is an exemplary transaction detail of the invention. Transaction detail 5600 includes transaction image 5602, transaction party signature 5604, and cardholder information 5606. Transaction image 5602 is the captured video image of transaction party 5302 during the transaction by camera 5111. Transaction image 5602 is the visual proof that transaction party 5302 is authenticating that he is the owner of the card. Transaction party signature 5604 is the digital signature of transaction party 5302 as captured by user input device 5110. In a different embodiment, an authenticated signature of the cardholder can be included in transaction detail 5600 for comparison with transaction party signature 5604. Cardholder information 5606 is the cardholder information captured by reader 5112.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for determining identities of transaction parties comprising:
capturing a transaction image of a transaction party conducting a transaction at a transaction device at the time of the transaction;
associating the transaction image with transaction information generated by the transaction device; and
using the transaction image to verify whether the transaction party has an authority to conduct the transaction.

2. The method of claim 1, wherein the associating includes cross-referencing the transaction image with the transaction information at the time of the transaction.

3. The method of claim 1, wherein the transaction information includes information related to one or more of date and time of the transaction.

4. The method of claim 1, wherein the transaction information includes information related to the transaction device.

5. A method for processing transactions comprising:
storing an authenticated image of a person authorized to conduct transactions at a transaction device;
capturing a transaction image of a transaction party conducting a transaction at the transaction device during the transaction; and
comparing the transaction image with the authenticated image to determine whether the transaction party shown in the transaction image is the person shown in the authenticated image.

6. The method of claim 5, wherein the authenticated image is captured when the person is authorized to use the transaction device.

7. The method of claim 5, wherein the authenticated image is one of previously undisputed transaction images.

8. The method of claim 5, wherein the comparing is performed before the transaction is approved.

9. The method of claim 8, further comprising approving the transaction based on a result of the comparing.

10. The method of claim 8, further comprising denying the transaction based on a result of the comparing.

11. The method of claim 6, wherein the comparing is performed after the transaction has been concluded.

12. The method of claim 11, wherein the comparing is performed for resolving a dispute related to the transaction.

13. The method of claim 11, wherein the comparing is performed for investigating illegitimate transaction purposes.

14. A system comprising:
a transaction device configured to generate transaction information associated with a transaction performed by a transaction party, wherein the transaction information is associated with a reference number;
an image device coupled to the transaction device, wherein the image device is configured to capture a transaction image of the transaction party while the transaction party is conducting the transaction at the transaction device, wherein the transaction image is associated with the reference number; and
a database coupled to the image device, wherein the database is configured to store the transaction image, wherein the transaction image is retrievable from the database using the reference number.

15. The system of claim 14, wherein the transaction device is an electronic device that is configured to verify identity of transaction parties electronically.

16. The system of claim 14, wherein the transaction device is an automatic teller machine.

17. The system of claim 14, wherein the transaction device is a point of sale terminal.

18. The system of claim 14, wherein the transaction device is a passport scanning machine.

19. The system of claim 14, wherein the image device is a camera.

20. The system of claim 14, wherein the camera is a video recording device.
